(19) United States
(12) Patent Application Publication
(10) Pub. No.: US 2013/0147686 A1
(43) Pub. Date: Jun. 13, 2013

(54) Connecting Head Mounted Displays To External Displays And Other Communication Networks

(71) Applicants: John Clavin, Seattle, WA (US); Ben Sugden, Woodinville, WA (US); Stephen G. Latta, Seattle, WA (US); Benjamin I. Vaught, Seattle, WA (US); Michael Scavezze, Bellevue, WA (US); Jonathan T. Steed, Redmond, WA (US); Ryan Hastings, Seattle, WA (US); Adam G. Poulos, Redmond, WA (US)

(72) Inventors: John Clavin, Seattle, WA (US); Ben Sugden, Woodinville, WA (US); Stephen G. Latta, Seattle, WA (US); Benjamin I. Vaught, Seattle, WA (US); Michael Scavezze, Bellevue, WA (US); Jonathan T. Steed, Redmond, WA (US); Ryan Hastings, Seattle, WA (US); Adam G. Poulos, Redmond, WA (US)

(21) Appl. No.: 13/316,888

(22) Filed: Dec. 12, 2011

(51) Int. Cl. G09G 5/00

(52) U.S. Cl. 345/8

(57) ABSTRACT

An audio and/or visual experience of a see-through head-mounted display (HMD) device, e.g., in the form of glasses, can be moved to target computing device such as a television, cell phone, or computer monitor to allow the user to seamlessly transition the content to the target computing device. For example, when the user enters a room in the home with a television, a movie which is playing on the HMD device can be transferred to the television and begin playing there without substantially interrupting the flow of the movie. The HMD device can inform the television of a network address for accessing the movie, for instance, and provide a current status in the form of a time stamp or packet identifier. Content can also be transferred in the reverse direction, to the HMD device. A transfer can occur based on location, preconfigured settings and user commands.

### BACKGROUND

Head-mounted display (HMD) devices have networked applications with fields including military, aviation, medicine, gaming or other entertainment, sports, and so forth. An HMD device may provide networked services to another HMD device, as well as participate in established communication networks. For example, in a military application, an HMD device allows a paratrooper to visualize a landing zone, or a fighter pilot to visualize targets based on thermal imaging data. In a general aviation application, an HMD device allows a pilot to visualize a ground map, instrument readings or a flight path. In a gaming application, an HMD device allows the user to participate in a virtual world using an avatar. In another entertainment application, an HMD device can play a movie or music. In a sports application, an HMD device can display race data to a race car driver. Many other applications are possible.

### SUMMARY

An HMD device typically includes at least one see-through lens, at least one image projection source, and at least one control circuit in communication with the at least one image projection source. The at least one control circuit provides an experience comprising at least one of audio and visual content at the head-mounted display device. For example, the content can include a movie, a gaming or entertainment application, a location-aware application or an application which provides one or more static images. The content can be audio only or visual only, or a combination of audio and visual content. The content can be passive consumed by the user or interactive, where the user provides control inputs such as by voice, hand gestures or manual control of an input device such as a game controller. In some cases, the HMD experience is all-consuming and the user is not able to perform other tasks while using the HMD device. In other cases, the HMD experience allows the user to perform other tasks, such as walking down a street. The HMD experience may also augment another task that the user is performing, such as displaying a recipe while the user is cooking. While current HMD experiences are useful and entertaining, it would be even more useful to take advantage of other computing devices in appropriate situations by moving the experience between the HMD device and another computing device.

As described herein, techniques and circuitry are provided which allow a user to continue an audio/visual experience at another computing device, or to continue an audio/visual experience at another computing device using the HMD device.

In one embodiment, an HMD device is provided which includes at least one see-through lens, at least one image projection source, and at least one control circuit. The at least one control circuit determines if a condition is met to provide a continuation of at least part of an experience at the HMD device at a target computing device, such as a cell phone, tablet, PC, television, computer monitor, projector, pico projector, another HMD device and the like. The condition can be based on, e.g., a location of the HMD device, a gesture performed by the user, a voice command made by the user, a gaze direction of the user, a proximity signal, an infrared signal, a bump of the HMD device, and a pairing of the HMD device with the target computing device. The at least one control circuit can determine one or more capabilities of the target computing device, and process the content accordingly to provide processed content to the target computing device. If the condition is met, the at least one control circuit communicates data to the target computing device to allow the target computing device to provide the continuation of at least part of the experience.

This summary is provided to introduce a selection of concepts in a simplified form that are further described below in the description. This summary is not intended to identify key features or essential features of the claimed subject matter, nor is it intended to be used to limit the scope of the claimed subject matter.

### BRIEF DESCRIPTION OF THE DRAWINGS

In the drawings, like-numbered elements correspond to one another.

FIG. 1 is a block diagram depicting example components of one embodiment of an HMD device in communication with a hub computing system 12.

FIG. 2 is a top view of a portion of one embodiment of the HMD device 2 of FIG. 1.

FIG. 3 is a block diagram of one embodiment of the components of the HMD device 2 of FIG. 1.

FIG. 4 is a block diagram of one embodiment of the components of the processing unit 4 of the HMD device 2 of FIG. 1.

FIG. 5 is a block diagram of one embodiment of the components of the hub computing system 12 and the capture device 20 of FIG. 1.

FIG. 6 is a block diagram depicting computing devices in a multi-user system.

FIG. 7 depicts a block diagram of an example of one of the computing devices of FIG. 6.

FIG. 8 depicts an example system in which two of the computing devices of FIG. 6 are paired.

FIG. 9A is a flow chart describing one embodiment of a process for continuing an experience on a target computing device.

FIG. 9B depicts various techniques by which a computing device can determine its location.

FIG. 10A depicts an example scenario of step 904 of FIG. 9A for determining if a condition is met to continue an experience on a target computing device or display surface.

FIG. 10B depicts another example scenario of step 904 of FIG. 9A for determining if a condition is met to continue an experience on a target computing device or display surface.

FIG. 10C depicts another example scenario of step 904 of FIG. 9A for determining if a condition is met to continue an experience on a target computing device.

FIG. 11 is a flow chart describing further details of step 906 or 914 of FIG. 9A for communicating data to a target computing device.

FIG. 12 depicts a process for tracking a user's gaze direction and depth of focus such as for use in step 904 or 914 of FIG. 9A.

FIG. 13 depicts various communication scenarios involving one or more HMD devices and one or more other computing devices.

FIG. 14A depicts a scenario in which an experience at an HMD device is continued at a target computing device such as the television 1300 of FIG. 13, based on a location of the HMD device.

FIG. 14B depicts a scenario in which an experience at an HMD device is continued at a television which is local to the HMD device and at a television which is remote from the HMD device, based on a location of the HMD device.

FIG. 14C depicts a scenario in which visual data of an experience at an HMD device is continued at a computing device such as the television 1300 of FIG. 13, and audio data of an experience at an HMD device is continued at a computing device such as a home high-fidelity or stereo system.

FIG. 15 depicts a scenario in which an experience at an HMD device is continued at a computing device such as a cell phone, based on a voice command of a user of the HMD device.

FIG. 16 depicts a scenario in which only the audio portion of an experience at an HMD device is continued at a computing device in a vehicle.

FIG. 17A depicts a scenario in which an experience at a computing device at a business is continued at an HMD device.

FIG. 17B depicts a scenario in which the experience of FIG. 17A includes user-generated content.

FIG. 17C depicts a scenario in which a user generates content for the experience of FIG. 17A.

FIG. 18 depicts an example scenario based on step 909 of FIG. 9A, describing a process for moving visual content from an initial virtual location to a virtual location which is registered to a display surface.

### DETAILED DESCRIPTION

See-through HMD devices can use optical elements such as mirrors, prisms, and holographic lenses to add light from one or two small image projection sources into a user's visual path. The light provides images to the user's eyes via see-through lenses. The images can include static or moving images, augmented reality images, text, video and so forth. An HMD device can also provide audio which accompanies the images or is played without an accompanying image, when the HMD device functions as an audio player. Other computing devices which are not HMD devices, such as a cell phone (e.g., a web-enabled smart phone), tablet, PC, television, computer monitor projector, or pico projector, can similarly provide audio and/or visual content. These are non-HMD devices. An HMD by itself can therefore provide many interesting and educational experiences for the user. However, there are situations in which it is desirable to move the experience of audio and/or visual content to a different device, such as for reasons of convenience, safety, sharing or to take advantage of the superiority ability of target computing device to render the audio and/or visual content (e.g., to watch a movie on a larger screen or to listen to audio on a high fidelity audio system). Various scenarios exists where an experience can be moved, and various mechanisms exist for achieving the movement of the experience including audio and/or visual content and associated data or metadata.

Features include: moving content (audio and/or visual) on an HMD device to another type of computing device, mechanisms for moving the content, state storage of image sequence on an HMD device and translation/conversion into equivalent state information for the destination device, context sensitive triggers to allow/block a transfer of content depending on circumstances, gestures associated with a transfer (bidirectional, to an external display and back), allowing dual mode (both screens/many screens) for sharing, even when an external display is physically remote from the main user, transfer of some form of device capabilities so user understands type of experience the other display will allow, and tagged external displays that allow specific rich information to be shown to the HMD device user.

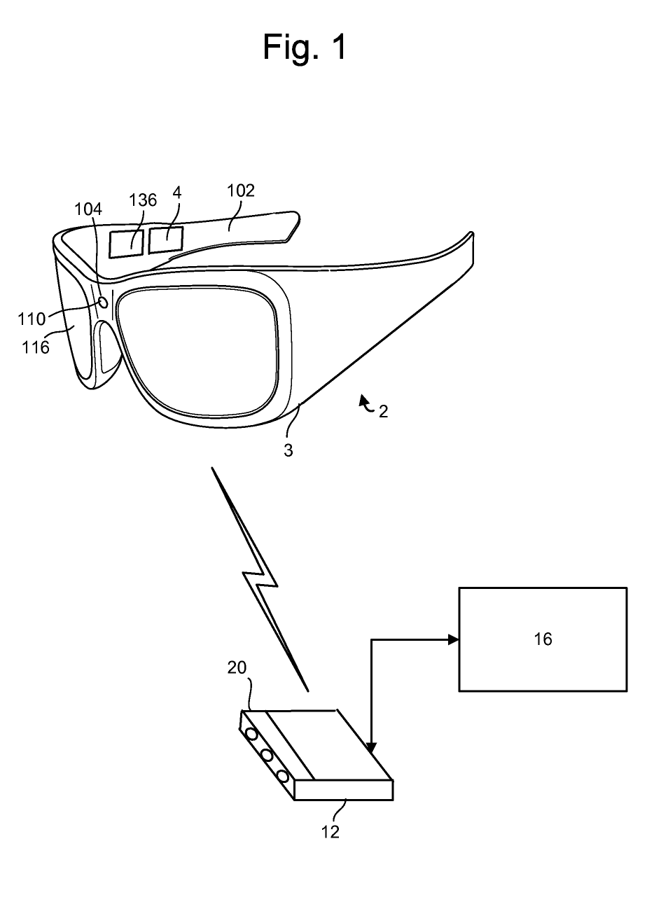

FIG. 1 is a block diagram depicting example components of one embodiment of an HMD device 2. A head-mounted frame 3 which can be generally in the shape of an eyeglass frame, and include a temple 102, and a front lens frame including a nose bridge 104. The HMD can have various capabilities, including capabilities to display images to the user via the lenses, capture images which the user is looking at via a forward-facing camera, play audio for the user via an earphone type speaker, and capture audio of the user, such as spoken words, via a microphone. These capabilities can be provided by various components and sensors as described below. The configuration described is an example only as many other configurations are possible. Circuitry which provides these capabilities can be built into the HMD device.

In an example configuration, a microphone 110 is built into the nose bridge 104 for recording sounds and transmitting that audio data to processing unit 4. Alternatively, a microphone can be attached to the HMD device via a boom/arm. Lens 116 is a see-through lens.

The HMD device can be worn on the head of a user so that the user can see through a display and thereby see a real-world scene which includes an image which is not generated by the HMD device. The HMD device 2 can be self-contained so that all of its components are carried by, e.g., physically supported by, the frame 3. Optionally, one or more components (e.g., which provide additional processing or data storage capability) are not carried by the frame, but can be connected by a wireless link or by a physical attachment such as a wire to a component carried by the frame. The off-frame components can be carried by the user, in one approach, such as on a wrist, leg or chest band, or attached to the user's clothing. The processing unit 4 could be connected to an on-frame component via a wire or via a wireless link. The term “HMD device” can encompass both on-frame and off-frame components. The off-frame component can be especially designed for use with the on-frame components or can be a standalone computing device such as a cell phone which is adapted for use with the on-frame components.

The processing unit 4 includes much of the computing power used to operate HMD device 2, and may execute instructions stored on a processor readable storage device for performing the processes described herein. In one embodiment, the processing unit 4 communicates wirelessly (e.g., using Wi-Fi® (IEEE 802.11), BLUETOOTH® (IEEE 802.15.1), infrared (e.g., IrDA® or INFRARED DATA ASSOCIATION® standard), or other wireless communication means) to one or more hub computing systems 12 and/or one or more other computing devices such as a cell phone, tablet, PC, television, computer monitor, projector or pico projector. The processing unit 4 could also include a wired connection to an assisting processor.

Control circuits 136 provide various electronics that support the other components of HMD device 2.

Hub computing system 12 may be a computer, a gaming system or console, or the like and may include hardware components and/or software components to execute gaming applications, non-gaming applications, or the like. The hub computing system 12 may include a processor that may execute instructions stored on a processor readable storage device for performing the processes described herein.

Hub computing system 12 further includes one or more capture devices 20, such as a camera that visually monitors one or more users and the surrounding space such that gestures and/or movements performed by the one or more users, as well as the structure of the surrounding space, may be captured, analyzed, and tracked to perform one or more controls or actions.

Hub computing system 12 may be connected to an audiovisual device 16 such as a television, a monitor, a high-definition television (HDTV), or the like that may provide game or application visuals. For example, hub computing system 12 may include a video adapter such as a graphics card and/or an audio adapter such as a sound card that may provide audiovisual signals associated with the game application, non-game application, etc. The audiovisual device 16 may receive the audiovisual signals from hub computing system 12 and may then output the game or application visuals and/or audio associated with the audiovisual signals.

Hub computing device 10, with capture device 20, may be used to recognize, analyze, and/or track human (and other types of) targets. For example, a user wearing the HMD device 2 may be tracked using the capture device 20 such that the gestures and/or movements of the user may be captured to animate an avatar or on-screen character and/or may be interpreted as controls that may be used to affect the application being executed by hub computing system 12.

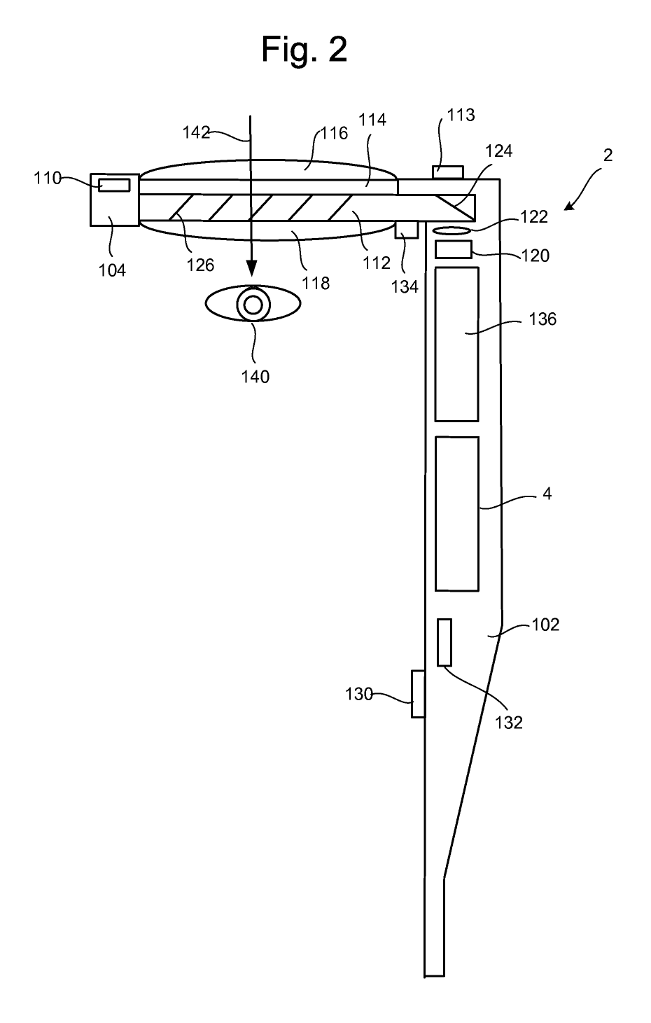

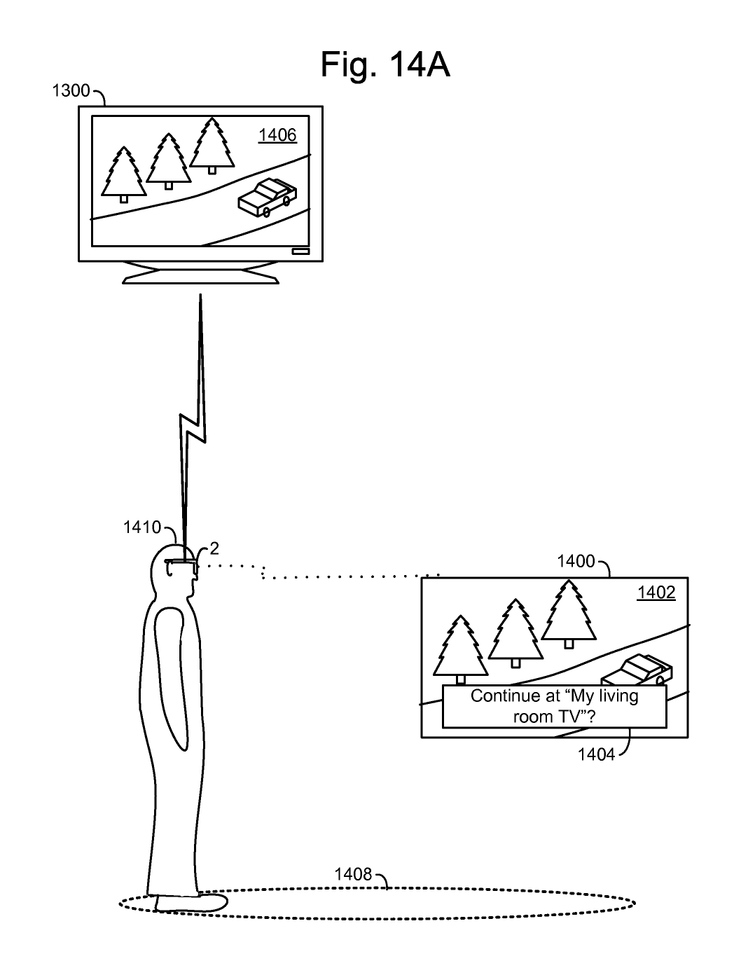

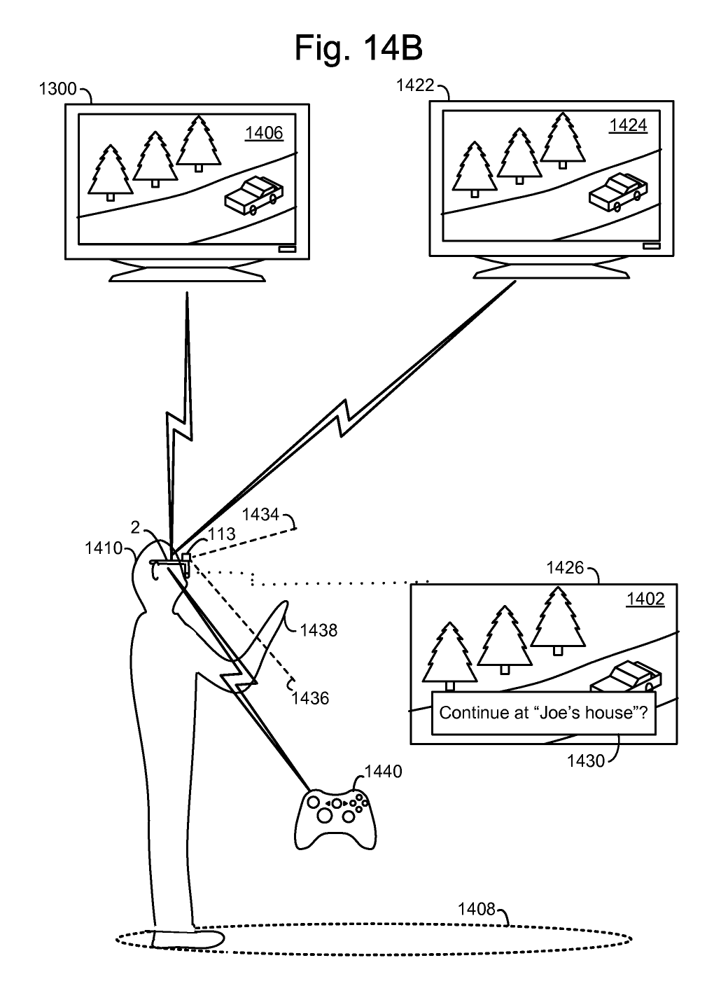

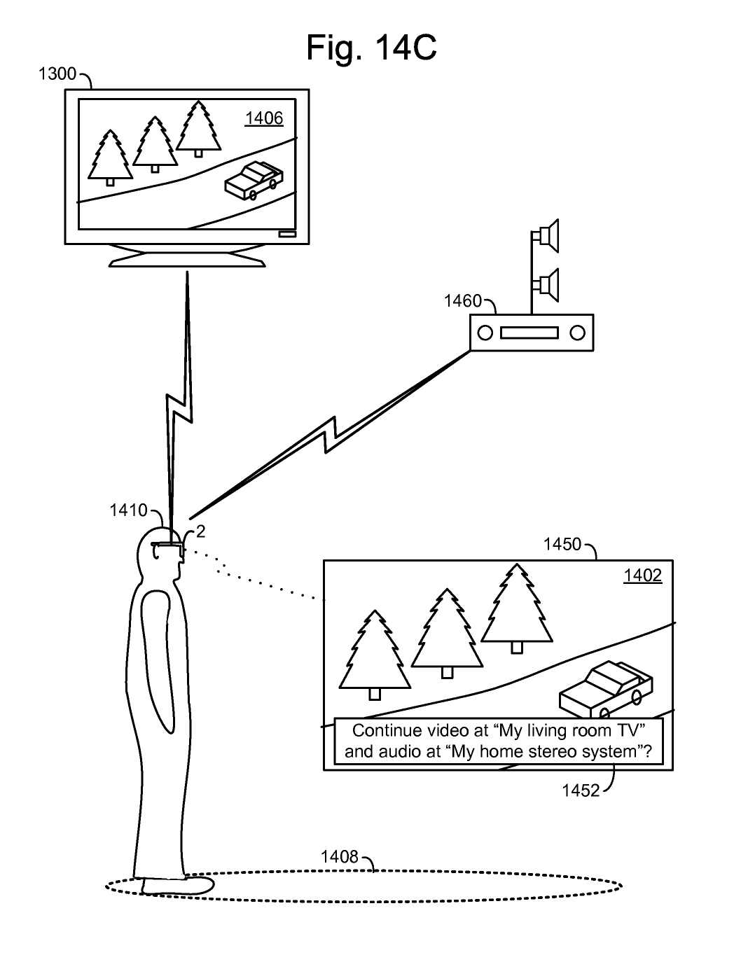

FIG. 2 is a top view of a portion of one embodiment of the HMD device 2 of FIG. 1, including a portion of the frame that includes temple 102 and nose bridge 104. Only the right side of HMD device 2 is depicted. At the front of HMD device 2 is a forward- or room-facing video camera 113 that can capture video and still images. Those images are transmitted to processing unit 4, as described below, and can be used, e.g., to detect gestures of the user such as a hand gesture which is interpreted as a command to perform an action such as to continue an experience at a target computing device such as described below in the example scenarios of FIGS. 14B, 15, 17A and 17B. The forward-facing video camera 113 faces outward and has a viewpoint similar to that of the user.

A portion of the frame of HMD device 2 surrounds a display that includes one or more lenses. A portion of the frame surrounding the display is not depicted. The display includes a light guide optical element 112, opacity filter 114, see-through lens 116 and see-through lens 118. In one embodiment, opacity filter 114 is behind and aligned with see-through lens 116, light guide optical element 112 is behind and aligned with opacity filter 114, and see-through lens 118 is behind and aligned with light guide optical element 112. See-through lenses 116 and 118 are standard lenses used in eye glasses. In some embodiments, HMD device 2 will include only one see-through lens or no see-through lenses. Opacity filter 114 filters out natural light (either on a per pixel basis or uniformly) to enhance the contrast of the imagery. Light guide optical element 112 channels artificial light to the eye.

Mounted to or inside temple 102 is an image projection source, which (in one embodiment) includes microdisplay 120 for projecting an image and lens 122 for directing images from microdisplay 120 into light guide optical element 112. In one embodiment, lens 122 is a collimating lens. An emitter can include microdisplay 120, one or more optical components such as the lens 122 and light guide 112, and associated electronics such as a driver. Such an emitter is associated with the HMD device, and emits light to a user's eye to provide images.

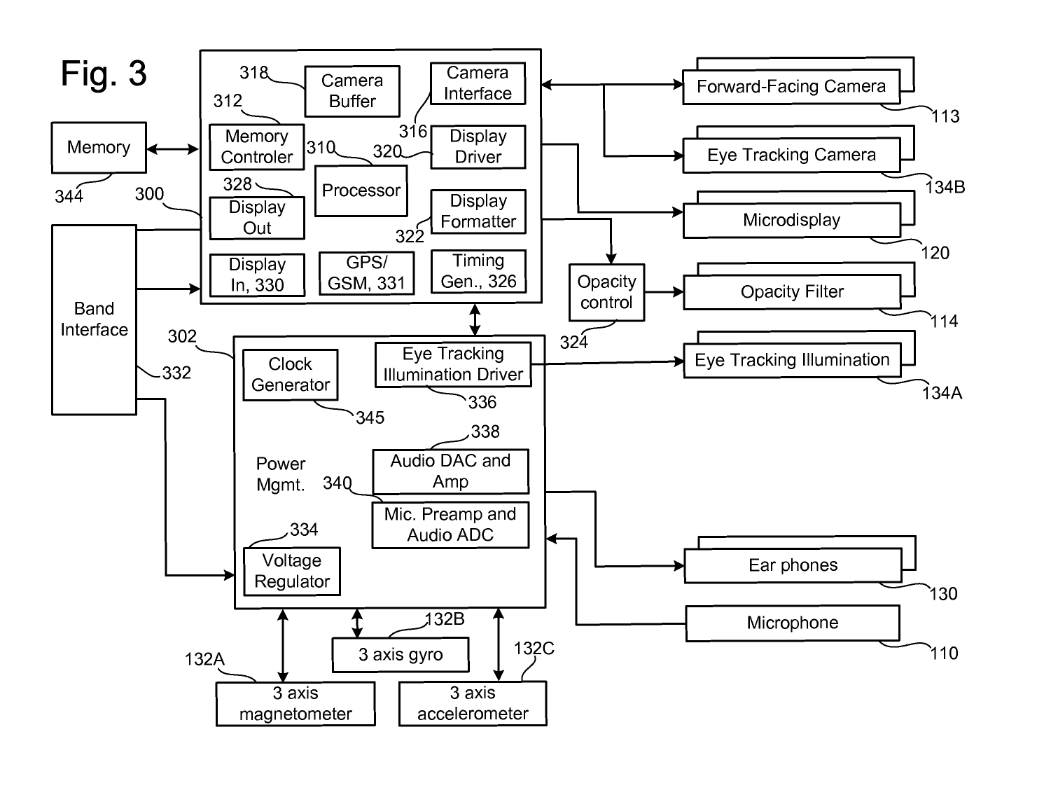

Control circuits 136 provide various electronics that support the other components of HMD device 2. More details of control circuits 136 are provided below with respect to FIG. 3. Inside, or mounted to temple 102, are ear phones 130 and inertial sensors 132. In one embodiment, inertial sensors 132 include a three axis magnetometer 132A, three axis gyro 132B and three axis accelerometer 132C (See FIG. 3). The inertial sensors are for sensing position, orientation and sudden accelerations of HMD device 2 (such as a bump of the computing device with target computing device or object). For example, the inertial sensors can be one or more sensors which are used to determine an orientation and/or location of user's head.

Microdisplay 120 projects an image through lens 122. Different image generation technologies can be used. For example, with a transmissive projection technology, the light source is modulated by optically active material, and backlit with white light. These technologies are usually implemented using LCD type displays with powerful backlights and high optical energy densities. With a reflective technology, external light is reflected and modulated by an optically active material. The illumination is forward lit by either a white source or RGB source, depending on the technology. Digital light processing (DGP), liquid crystal on silicon (LCOS) and MIRASOL® (a display technology from QUALCOMM®, INC.) are examples of reflective technologies which are efficient as most energy is reflected away from the modulated structure. With an emissive technology, light is generated by the display. For example, a PicoP™-display engine (available from MICROVISION, INC.) emits a laser signal with a micro mirror steering either onto a tiny screen that acts as a transmissive element or beamed directly into the eye.

Light guide optical element 112 transmits light from microdisplay 120 to the eye 140 of the user wearing the HMD device 2. Light guide optical element 112 also allows light from in front of the HMD device 2 to be transmitted through light guide optical element 112 to eye 140, as depicted by arrow 142, thereby allowing the user to have an actual direct view of the space in front of HMD device 2, in addition to receiving an image from microdisplay 120. Thus, the walls of light guide optical element 112 are see-through. Light guide optical element 112 includes a first reflecting surface 124 (e.g., a mirror or other surface). Light from microdisplay 120 passes through lens 122 and is incident on reflecting surface 124. The reflecting surface 124 reflects the incident light from the microdisplay 120 such that light is trapped inside a planar, substrate comprising light guide optical element 112 by internal reflection. After several reflections off the surfaces of the substrate, the trapped light waves reach an array of selectively reflecting surfaces, including example surface 126.

Reflecting surfaces 126 couple the light waves incident upon those reflecting surfaces out of the substrate into the eye 140 of the user. As different light rays will travel and bounce off the inside of the substrate at different angles, the different rays will hit the various reflecting surface 126 at different angles. Therefore, different light rays will be reflected out of the substrate by different ones of the reflecting surfaces. The selection of which light rays will be reflected out of the substrate by which surface 126 is engineered by selecting an appropriate angle of the surfaces 126. In one embodiment, each eye will have its own light guide optical element 112. When the HMD device has two light guide optical elements, each eye can have its own microdisplay 120 that can display the same image in both eyes or different images in the two eyes. In another embodiment, there can be one light guide optical element which reflects light into both eyes.

Opacity filter 114, which is aligned with light guide optical element 112, selectively blocks natural light, either uniformly or on a per-pixel basis, from passing through light guide optical element 112. In one embodiment, the opacity filter can be a see-through LCD panel, electrochromic film, or similar device. A see-through LCD panel can be obtained by removing various layers of substrate, backlight and diffusers from a conventional LCD. The LCD panel can include one or more light-transmissive LCD chips which allow light to pass through the liquid crystal. Such chips are used in LCD projectors, for instance.

Opacity filter 114 can include a dense grid of pixels, where the light transmissivity of each pixel is individually controllable between minimum and maximum transmissivities. A transmissivity can be set for each pixel by the opacity filter control circuit 224, described below.

In one embodiment, the display and the opacity filter are rendered simultaneously and are calibrated to a user's precise position in space to compensate for angle-offset issues. Eye tracking (e.g., using eye tracking camera 134) can be employed to compute the correct image offset at the extremities of the viewing field.

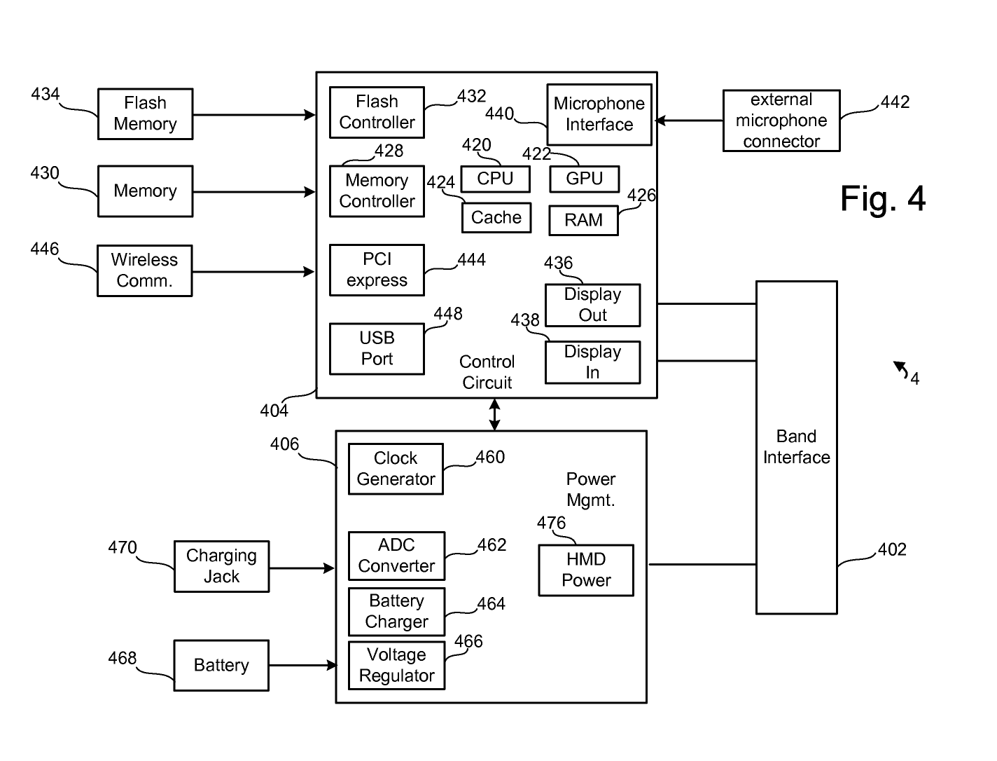

FIG. 3 is a block diagram of one embodiment of the components of the HMD device 2 of FIG. 1. FIG. 4 is a block diagram of one embodiment of the components of the processing unit 4 of the HMD device 2 of FIG. 1. The HMD device components include many sensors that track various conditions. The HMD device will receive instructions about the image from processing unit 4 and will provide the sensor information back to processing unit 4. Processing unit 4 receives the sensory information of the HMD device 2. Optionally, the processing unit 4 also receives sensory information from hub computing device 12 (See FIG. 1). Based on that information, processing unit 4 will determine where and when to provide an image to the user and send instructions accordingly to the components of FIG. 3.

Note that some of the components of FIG. 3 (e.g., forward facing camera 113, eye tracking camera 134B, microdisplay 120, opacity filter 114, eye tracking illumination 134A and earphones 130) are shown in shadow to indicate that there are two of each of those devices, one for the left side and one for the right side of HMD device. Regarding the forward-facing camera 113, in one approach, one camera is used to obtain images using visible light.

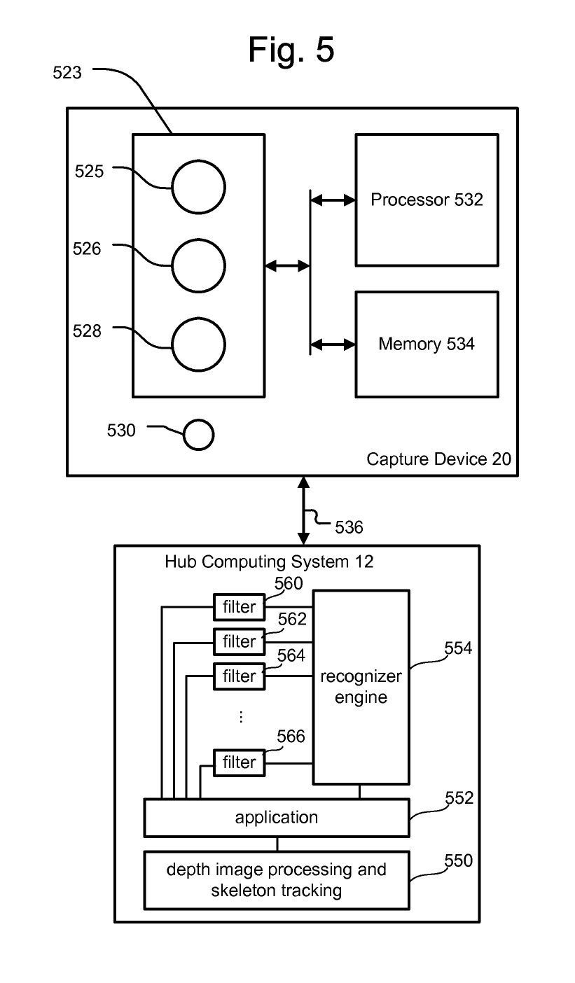

In another approach, two or more cameras with a known spacing between them are used as a depth camera to also obtain depth data for objects in a room, indicating the distance from the cameras/HMD device to the object. The forward cameras of the HMD device can essentially duplicate the functionality of the depth camera provided by the computer hub 12 (see also capture device 20 of FIG. 5).

Images from forward facing cameras can be used to identify people and other objects in a field of view of the user, as well as gestures such as a hand gesture of the user.

FIG. 3 shows a control circuit 300 in communication with a power management circuit 302. Control circuit 300 includes processor 310, memory controller 312 in communication with memory 344 (e.g., DRAM), camera interface 316, camera buffer 318, display driver 320, display formatter 322, timing generator 326, display out interface 328, and display in interface 330. In one embodiment, all of components of control circuit 300 are in communication with each other via dedicated lines or one or more buses. In another embodiment, each of the components of control circuit 300 is in communication with processor 310. Camera interface 316 provides an interface to the two forward facing cameras 113 and stores images received from the forward facing cameras in camera buffer 318. Display driver 320 drives microdisplay 120. Display formatter 322 provides information, about the image being displayed on microdisplay 120, to opacity control circuit 324, which controls opacity filter 114. Timing generator 326 is used to provide timing data for the system. Display out interface 328 is a buffer for providing images from forward facing cameras 112 to the processing unit 4. Display in interface 330 is a buffer for receiving images such as an image to be displayed on microdisplay 120. A circuit 331 can be used to determine location based on Global Positioning System (GPS) GPS signals and/or Global System for Mobile communication (GSM) signals.

Display out interface 328 and display in interface 330 communicate with band interface 332 which is an interface to processing unit 4, when the processing unit is attached to the frame of the HMD device by a wire, or communicates by a wireless link, and is worn on the body, such as on an arm, leg or chest band or in clothing. This approach reduces the weight of the frame-carried components of the HMD device. In other approaches, as mentioned, the processing unit can be carried by the frame and a band interface is not used.

Power management circuit 302 includes voltage regulator 334, eye tracking illumination driver 336, audio DAC and amplifier 338, microphone preamplifier audio ADC 340 and clock generator 345. Voltage regulator 334 receives power from processing unit 4 via band interface 332 and provides that power to the other components of HMD device 2. Eye tracking illumination driver 336 provides the infrared (IR) light source for eye tracking illumination 134A, as described above. Audio DAC and amplifier 338 provides audio information to the earphones 130. Microphone preamplifier and audio ADC 340 provide an interface for microphone 110. Power management unit 302 also provides power and receives data back from three-axis magnetometer 132A, three-axis gyroscope 132B and three axis accelerometer 132C.

FIG. 4 is a block diagram describing the various components of processing unit 4. Control circuit 404 is in communication with power management circuit 406. Control circuit 404 includes a central processing unit (CPU) 420, graphics processing unit (GPU) 422, cache 424, RAM 426, memory control 428 in communication with memory 430 (e.g., DRAM), flash memory controller 432 in communication with flash memory 434 (or other type of non-volatile storage), display out buffer 436 in communication with HMD device 2 via band interface 402 and band interface 332 (when used), display in buffer 438 in communication with HMD device 2 via band interface 402 and band interface 332 (when used), microphone interface 440 in communication with an external microphone connector 442 for connecting to a microphone, Peripheral Component Interconnect (PCI) express interface 444 for connecting to a wireless communication device 446, and USB port(s) 448.

In one embodiment, wireless communication component 446 can include a Wi-Fi® enabled communication device, BLUETOOTH® communication device and an infrared communication device. The wireless communication component 446 is a wireless communication interface which, in one implementation, receives data in synchronism with the content displayed by the audiovisual device 16. Further, images may be displayed in response to the received data. In one approach, such data is received from the hub computing system 12. The wireless communication component 446 can also be used to provide data to a target computing device to continue an experience of the HMD device at the target computing device. The wireless communication component 446 can also be used to receive data from another computing device to continue an experience of that computing device at the HMD device.

The USB port can be used to dock the processing unit 4 to hub computing device 12 to load data or software onto processing unit 4, as well as charge processing unit 4. In one embodiment, CPU 420 and GPU 422 are the main workhorses for determining where, when and how to insert images into the view of the user. More details are provided below.

Power management circuit 406 includes clock generator 460, analog to digital converter 462, battery charger 464, voltage regulator 466 and HMD power source 476. Analog to digital converter 462 is connected to a charging jack 470 for receiving an AC supply and creating a DC supply for the system. Voltage regulator 466 is in communication with battery 468 for supplying power to the system. Battery charger 464 is used to charge battery 468 (via voltage regulator 466) upon receiving power from charging jack 470. HMD power source 476 provides power to the HMD device 2.

The calculations that determine where, how and when to insert an image can be performed by the HMD device 2 and/or the hub computing device 12.

In one example embodiment, hub computing device 12 will create a model of the environment that the user is in and track various moving objects in that environment. In addition, hub computing device 12 tracks the field of view of the HMD device 2 by tracking the position and orientation of HMD device 2. The model and the tracking information are provided from hub computing device 12 to processing unit 4. Sensor information obtained by HMD device 2 is transmitted to processing unit 4. Processing unit 4 then uses additional sensor information it receives from HMD device 2 to refine the field of view of the user and provide instructions to HMD device 2 on how, where and when to insert the image.

FIG. 5 illustrates an example embodiment of the hub computing system 12 and the capture device 20 of FIG. 1. However, the description can also apply to the HMD device, where the capture device uses the forward-facing video camera 113 to obtain images, and the images are processed to detect a gesture such as a hand gesture, for instance. According to an example embodiment, capture device 20 may be configured to capture video with depth information including a depth image that may include depth values via any suitable technique including, for example, time-of-flight, structured light, stereo image, or the like. According to one embodiment, the capture device 20 may organize the depth information into “Z layers,” or layers that may be perpendicular to a Z axis extending from the depth camera along its line of sight.

Capture device 20 may include a camera component 523, which may be or may include a depth camera that may capture a depth image of a scene. The depth image may include a two-dimensional (2-D) pixel area of the captured scene where each pixel in the 2-D pixel area may represent a depth value such as a distance in, for example, centimeters, millimeters, or the like of an object in the captured scene from the camera.

Camera component 523 may include an infrared (IR) light component 525, an infrared camera 526, and an RGB (visual image) camera 528 that may be used to capture the depth image of a scene. A 3-D camera is formed by the combination of the infrared emitter 24 and the infrared camera 26. For example, in time-of-flight analysis, the IR light component 525 of the capture device 20 may emit an infrared light onto the scene and may then use sensors (in some embodiments, including sensors not shown) to detect the backscattered light from the surface of one or more targets and objects in the scene using, for example, the 3-D camera 526 and/or the RGB camera 528. In some embodiments, pulsed infrared light may be used such that the time between an outgoing light pulse and a corresponding incoming light pulse may be measured and used to determine a physical distance from the capture device 20 to a particular location on the targets or objects in the scene. Additionally, the phase of the outgoing light wave may be compared to the phase of the incoming light wave to determine a phase shift. The phase shift may then be used to determine a physical distance from the capture device to a particular location on the targets or objects.

A time-of-flight analysis may be used to indirectly determine a physical distance from the capture device 20 to a particular location on the targets or objects by analyzing the intensity of the reflected beam of light over time via various techniques including, for example, shuttered light pulse imaging.

The capture device 20 may use a structured light to capture depth information. In such an analysis, patterned light (i.e., light displayed as a known pattern such as grid pattern, a stripe pattern, or different pattern) may be projected onto the scene via, for example, the IR light component 525. Upon striking the surface of one or more targets or objects in the scene, the pattern may become deformed in response. Such a deformation of the pattern may be captured by, for example, the 3-D camera 526 and/or the RGB camera 528 (and/or other sensor) and may then be analyzed to determine a physical distance from the capture device to a particular location on the targets or objects. In some implementations, the IR light component 525 is displaced from the cameras 526 and 528 so triangulation can be used to determined distance from cameras 526 and 528. In some implementations, the capture device 20 will include a dedicated IR sensor to sense the IR light, or a sensor with an IR filter.

The capture device 20 may include two or more physically separated cameras that may view a scene from different angles to obtain visual stereo data that may be resolved to generate depth information. Other types of depth image sensors can also be used to create a depth image.

The capture device 20 may further include a microphone 530, which includes a transducer or sensor that may receive and convert sound into an electrical signal. Microphone 530 may be used to receive audio signals that may also be provided by hub computing system 12.

A processor 532 is in communication with the image camera component 523. Processor 532 may include a standardized processor, a specialized processor, a microprocessor, or the like that may execute instructions including, for example, instructions for receiving a depth image, generating the appropriate data format (e.g., frame) and transmitting the data to hub computing system 12.

A memory 534 stores the instructions that are executed by processor 532, images or frames of images captured by the 3-D camera and/or RGB camera, or any other suitable information, images, or the like. According to an example embodiment, memory 534 may include RAM, ROM, cache, flash memory, a hard disk, or any other suitable storage component. Memory 534 may be a separate component in communication with the image capture component 523 and processor 532. According to another embodiment, the memory 534 may be integrated into processor 532 and/or the image capture component 523.

Capture device 20 is in communication with hub computing system 12 via a communication link 536. The communication link 536 may be a wired connection including, for example, a USB connection, a FireWire connection, an Ethernet cable connection, or the like and/or a wireless connection such as a wireless 802.11b, g, a, or n connection. According to one embodiment, hub computing system 12 may provide a clock to capture device 20 that may be used to determine when to capture, for example, a scene via the communication link 536. Additionally, the capture device 20 provides the depth information and visual (e.g., RGB or other color) images captured by, for example, the 3-D camera 526 and/or the RGB camera 528 to hub computing system 12 via the communication link 536. In one embodiment, the depth images and visual images are transmitted at 30 frames per second; however, other frame rates can be used. Hub computing system 12 may then create and use a model, depth information, and captured images to, for example, control an application such as a game or word processor and/or animate an avatar or on-screen character.

Hub computing system 12 includes depth image processing and skeletal tracking module 550, which uses the depth images to track one or more persons detectable by the depth camera function of capture device 20. Module 550 provides the tracking information to application 552, which can be a video game, productivity application, communications application or other software application. The audio data and visual image data is also provided to application 552 and module 550. Application 552 provides the tracking information, audio data and visual image data to recognizer engine 554. In another embodiment, recognizer engine 554 receives the tracking information directly from module 550 and receives the audio data and visual image data directly from capture device 20.

Recognizer engine 554 is associated with a collection of filters 560, 562, 564, . . . , 566 each comprising information concerning a gesture, action or condition that may be performed by any person or object detectable by capture device 20. For example, the data from capture device 20 may be processed by filters 560, 562, 564, . . . , 566 to identify when a user or group of users has performed one or more gestures or other actions. Those gestures may be associated with various controls, objects or conditions of application 552. Thus, hub computing system 12 may use the recognizer engine 554, with the filters, to interpret and track movement of objects (including people).

Capture device 20 provides RGB images (or visual images in other formats or color spaces) and depth images to hub computing system 12. The depth image may be a set of observed pixels where each observed pixel has an observed depth value. For example, the depth image may include a two-dimensional (2-D) pixel area of the captured scene where each pixel in the 2-D pixel area may have a depth value such as distance of an object in the captured scene from the capture device. Hub computing system 12 will use the RGB images and depth images to track a user's or object's movements.

FIG. 1, discussed previously, depicts one HMD device 2 (considered to be a type of terminal or computing device) in communication with one hub computing device 12 (referred to as a hub). In another embodiment, multiple user computing devices can be in communication with a single hub. Each computing device can be a mobile computing device such as a cell phone, tablet, laptop, personal digital assistant (PDA), or a fixed computing device such as a desktop/PC computer or game console. Each computing device typically includes the ability to store, process and present audio and/or visual data,

In one approach, each of the computing devices communicates with the hub using wireless communication, as described above. In such an embodiment, much of the information that is useful to all of the computing devices can be computed and stored at the hub and transmitted to each of the computing devices. For example, the hub will generate the model of the environment and provide that model to all of the computing devices in communication with the hub. Additionally, the hub can track the location and orientation of the computing devices and of the moving objects in the room, and then transfer that information to each of the computing devices.

The system could include multiple hubs, with each hub including one or more computing devices. The hubs can communicate with each other via one or more local area networks (LANs) or wide area networks (WANs) such as the Internet. A LAN can be a computer network that connects computing devices in a limited area such as a home, school, computer laboratory, or office building. A WAN can be a telecommunication network that covers a broad area such as to line across metropolitan, regional or national boundaries.

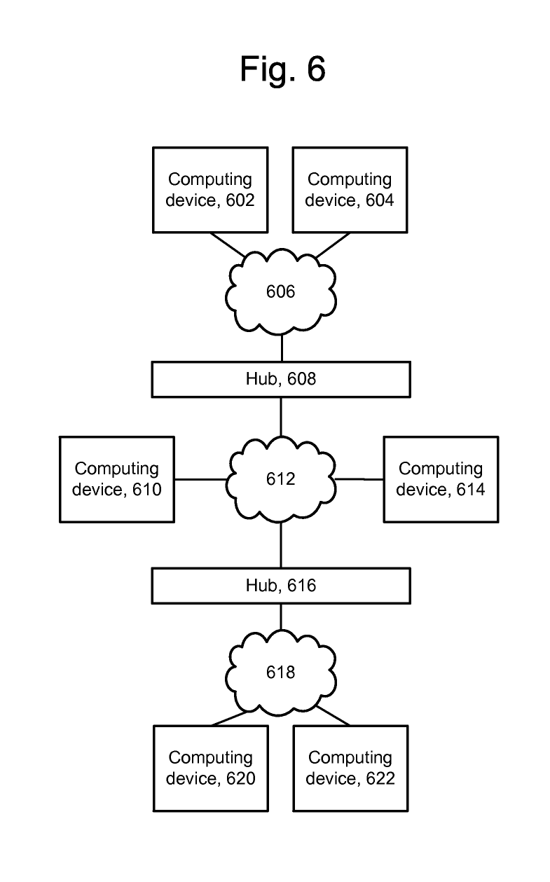

FIG. 6 is a block diagram depicting a multi-user system, including hubs 608 and 616 which communicate with one another via one or more networks 612 such as one or more LANs or WANs. Hub 608 communicates with computing devices 602 and 604 such as via one or more LANs 606, and Hub 616 communicates with computing devices 620 and 622 such as via one or more LANs 618. Information shared between hubs can include skeleton tracking, information about the models, various states of applications, and other tracking. The information communicated between the hubs and their respective computing devices include tracking information of moving objects, the state and physics updates for the world models, geometry and texture information, video and audio, and other information used to perform the operations described herein.

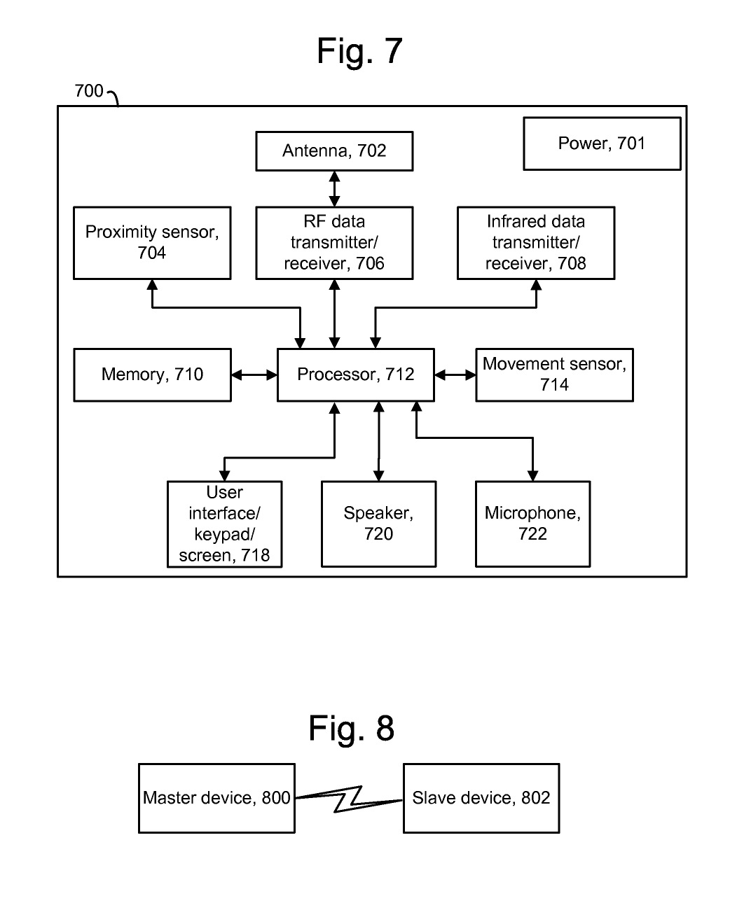

Computing devices 610 and 614 communicate with one another such as via the one or more networks 612 and do not communicate through a hub. The computing devices can be of the same or different types. In one example, the computing devices include HMD devices worn by respective users that communicate via, e.g., a Wi-Fi®, BLUETOOTH® or IrDA® link, for instance. In another example, one of the computing devices is an HMD device and another computing device is a display device such as a cell phone, tablet, PC, television, or smart board (e.g., menu board or white board) (FIG. 7).

At least one control circuit can be provided, e.g., by the hub computing system 12, processing unit 4, control circuit 136, processor 610, CPU 420, GPU 422, processor 532, console 600 and/or processor 712 (FIG. 7). The at least one control circuit can include one or more processors which execute instructions stored on one or more tangible, non-transitory processor-readable storage devices for performing methods described herein. At least one control circuit can also include the one or more tangible, non-transitory processor-readable storage devices, or other non-volatile or volatile storage devices. The storage device, as a computer-readable media, can be provided, e.g., by memory 344, cache 424, RAM 426, flash memory 434, memory 430, memory 534, memory 612, cache 602 or 604, memory 643, memory unit 646 and/or memory 710 (FIG. 7).

A hub can also communicate data, e.g., wirelessly, to an HMD device for rendering an image from a perspective of the user, based on a current orientation and/or location of the user's head which is transmitted to the hub. The data for rendering the image can be in synchronism with content displayed on a video display screen. In one approach, the data for rendering the image includes image data for controlling pixels of the display to provide an image in a specified virtual location. The image can include a 2-D or 3-D object as discussed further below which is rendered from the user's current perspective. The image data for controlling pixels of the display can be in a specified file format, for instance, where individual frames of images are specified.

In another approach, the image data for rendering the image is obtained from another source than the hub, such as via a local storage device which is included with the HMD or perhaps carried on the user's person, e.g., in a pocket or on a band, and connected to the head-mounted via a wire or wirelessly.

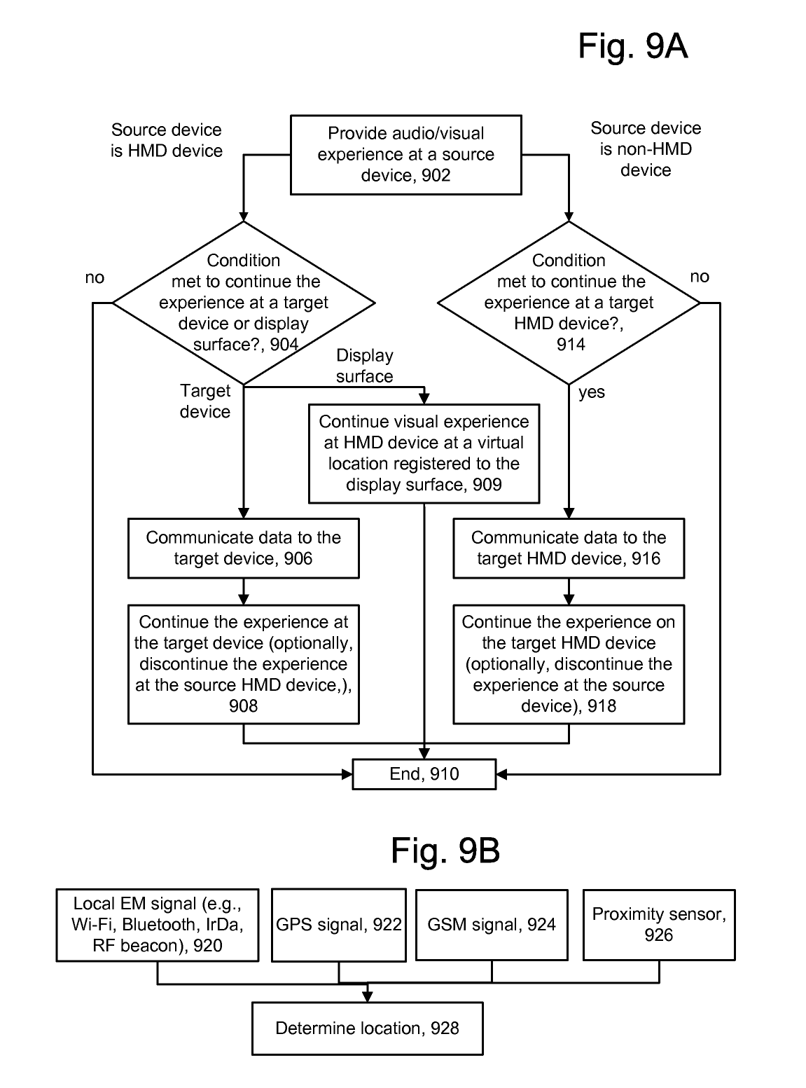

FIG. 7 depicts a block diagram of an example of one of the computing devices of FIG. 6. As mentioned in connection with FIG. 6, an HMD device can communicate directly with another terminal/computing device. Exemplary electronic circuitry of a typical computing device, which may not be an HMD device, is depicted. In an example computing device 700, The circuitry includes processor 712 that can include one or more microprocessors, and storage or memory 710 (e.g., non-volatile memory such as ROM and volatile memory such as RAM) which stores processor-readable code which is executed by one or more processors 712 to implement the functionality described herein. The processor 712 also communicates with an RF data transmit/receive circuitry 706 which in turn is coupled to an antenna 702, with an infrared data transmitted/receiver 708, and with a movement (e.g., bump) sensor 714 such as an accelerometer. The processor 712 also communicates with a proximity sensor 704. See FIG. 9B.

An accelerometer can be provided, e.g., by a micro-electromechanical system (MEMS) which is built onto a semiconductor chip. Acceleration direction, as well as orientation, vibration and shock can be sensed. The processor 712 further communicates with a UI keypad/screen 718, a speaker 720, and a microphone 722. A power source 701 is also provided.

In one approach, the processor 712 controls transmission and reception of wireless signals. Signals could also be sent via a wire. During a transmission mode, the processor 712 can provide data such as audio and/or visual content, or information for accessing such content, to the transmit/receive circuitry 706. The transmit/receive circuitry 706 transmits the signal to another computing device (e.g., an HMD device, other computing device, cellular phone, etc.) via antenna 702. During a receiving mode, the transmit/receive circuitry 706 receives such data from an HMD or other device through the antenna 702.

FIG. 8 depicts an example system in which two of the computing devices of FIG. 6 are paired. As mentioned, an HMD device can communicate with another computing device such as a cell phone, PC or the like using, e.g., a Wi-Fi®, BLUETOOTH® or IrDA® link. Here, the slave device communicates directly with the master device. The slave device is synchronized to a clock of the master device to allow the slave device and a master device to exchange messages (such as audio and/or visual data, or data for accessing such data) at specified times. The slave device can establish a connection with a master device in a connection-oriented protocol so that the slave device and the master device are said to be paired or connected.

In an example approach which is used in the BLUETOOTH® protocol, the master device enters an inquiry state to discover other computing devices in the area. This can be done in response to a manual user command or in response to detecting that the master device is in a certain location, for instance. In the inquiry state, the master device (a local device) generates and broadcasts an inquiry hopping (channel changing) sequence.

Discoverable computing devices (remote devices such as the HMD device 2) will periodically enter the inquiry scan state. If the remote device performing the inquiry scan receives an inquiry message, it enters the inquiry response state and replies with an inquiry response message. The inquiry response includes the remote device's address and clock, both of which are needed to establish a connection. All discoverable devices within the broadcast range will respond to the device inquiry.

After obtaining and selecting a remote device's address, the master device enters the paging state to establish a connection with the remote device.

Once the paging process is complete, the computing devices move to a connection state. If successful, the two devices continue frequency hopping in a pseudo-random pattern based on the master device's address and clock for the duration of the connection.

Although the BLUETOOTH® protocol is provided as an example, any type of protocol can be used in which computing devices are paired and communicate with one another. Optionally, multiple slave devices can be synchronized to one master device.

FIG. 9A is a flow chart describing one embodiment of a process for continuing a experience on target computing device. Step 902 includes providing an audio/visual experience at a source computing device. The audio/visual experience can include an experience of audio and/or video content, for instance. The experience can be interactive, such as in a gaming experience or non-interactive, such as when recorded video, image or audio data in a file is played. The source computing device can be an HMD or non-HMD computing device, for instance, which is the source of a transfer of the experience to another computing device, referred to as a target device. If the source computing device is an HMD device, decision step 904 determines if a condition is met to continue the experience on a target computing device (e.g., one or more target computing devices) or on a display surface. If decision step 904 is false, the process ends at step 910.

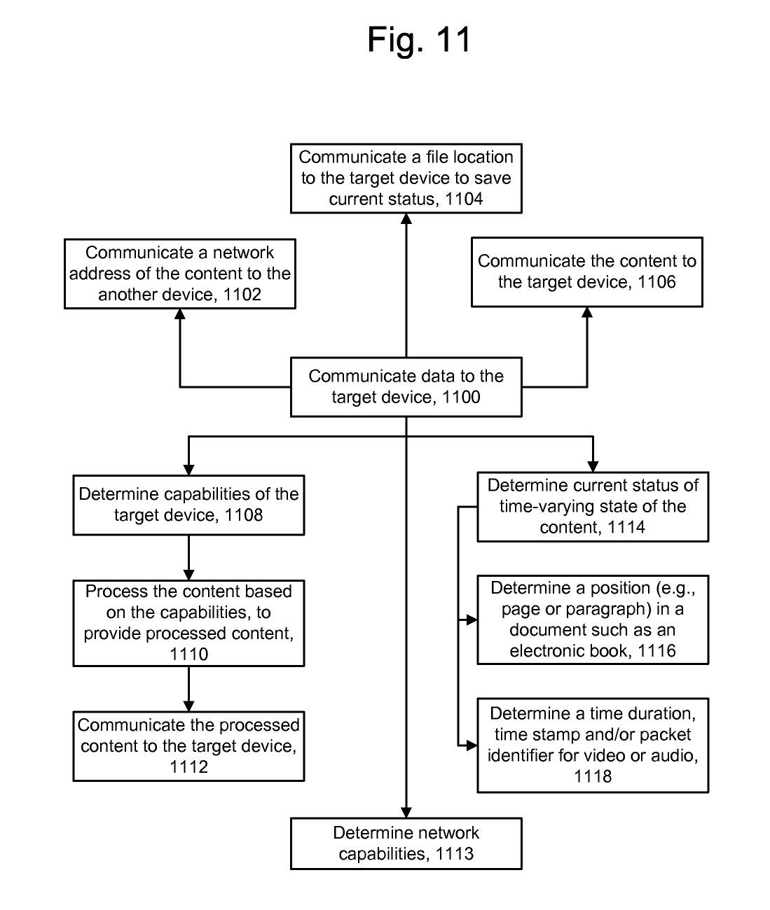

If decision step 904 indicates the experience should be continued on a target computing device, step 906 communicates data to the target computing device (see also FIG. 11), and step 908 continues the experience at the target computing device. Optionally, the experience is discontinued at the source HMD device. Thus, the continuing of an experience at a first computing device can involve a duplication/copy of the experience at a second computing device (or multiple other computing devices), so that the experience continues at the first computing device and begins at the second computing device, or a transfer/move of the experience from the first to the second computing device, so that it ends at the first computing device and begins at the second computing device.

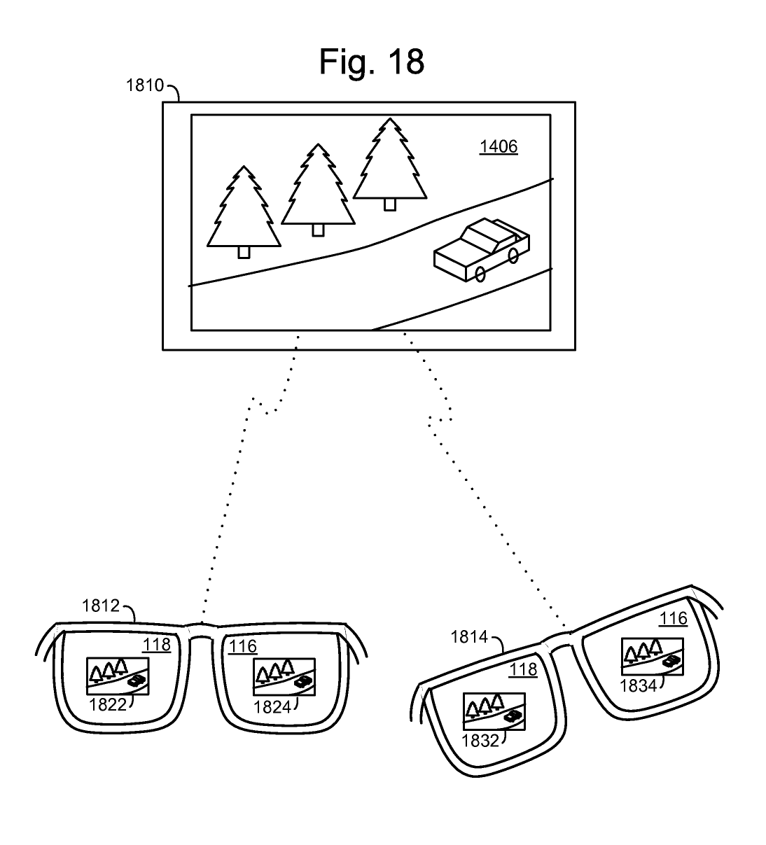

If decision step 904 indicates the experience should be continued on a display surface, step 909 displays the visual content at the source HMD device at a virtual location which is registered to the display surface. See FIG. 18 for further details.

In another branch which follows step 902, the source computing device is a non-HMD device. In this case, decision step 914 determines if a condition is met to continue the experience at a target HMD device. If decision step 914 is false, the process ends at step 910. If decision step 914 is true, step 916 communicates data to the target HMD device (see also FIG. 11), and step 918 continues the experience on the target HMD device. Optionally, the experience is discontinued at the source computing device.

The conditions mentioned in decision steps 904 and 914 can involve one or more factors such as locations of one or more of the source and/or target computing devices, one or more gestures performed by a user, manipulation by the user of a hardware-based input device such as a game controller, one or more voice commands made by a user, a gaze direction of a user, a proximity signal, an infrared signal, a bump, a pairing of the computing devices and preconfigured user and/or default settings and preferences. A game controller can include a keyboard, mouse, game pad, joysticks, or a special purpose device, such as a steering wheel for a driving games and a light gun for a shooting game. One or more capabilities of the source and/or target computing devices can also be considered in deciding whether the condition is met. For example, a source computing device's capabilities may indicate that it is not suitable to transfer certain content to.

A “bump” scenario could involve the user making a specific contact connection between the source computing device and the target computing device. In one approach, the user can take off the HMD device and bump/touch it to target computing device to indicate that content should be transferred. In another approach, the HMD device can use a companion device such as a cell phone which performs the bump. The companion device may have an assisting processor that helps with processing for the HMD device.

FIG. 9B depicts various techniques by which a computing device can determine its location. Location data can be obtained from one or more sources. These include local electromagnetic (EM) signals 920, such as from a Wi-Fi network, BLUETOOTH network, IrDA (infrared) and/or RF beacon. These are signals that can be emitted from within a particular location which a computing device visits, such as an office building, warehouse, retail establishment, home or the like.

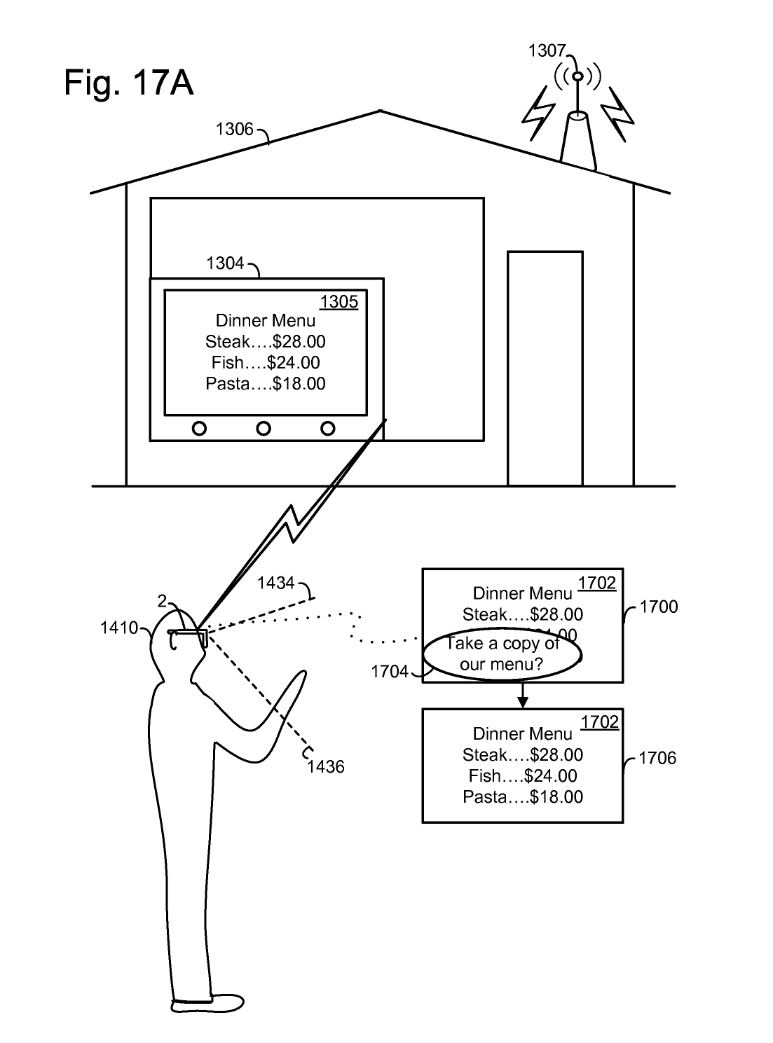

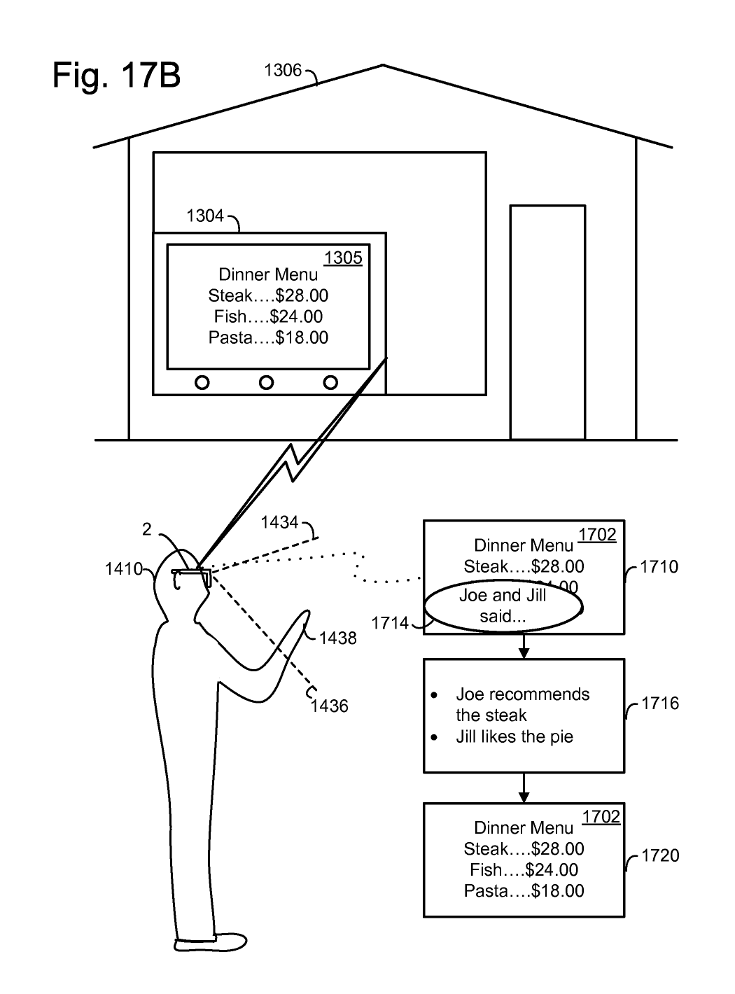

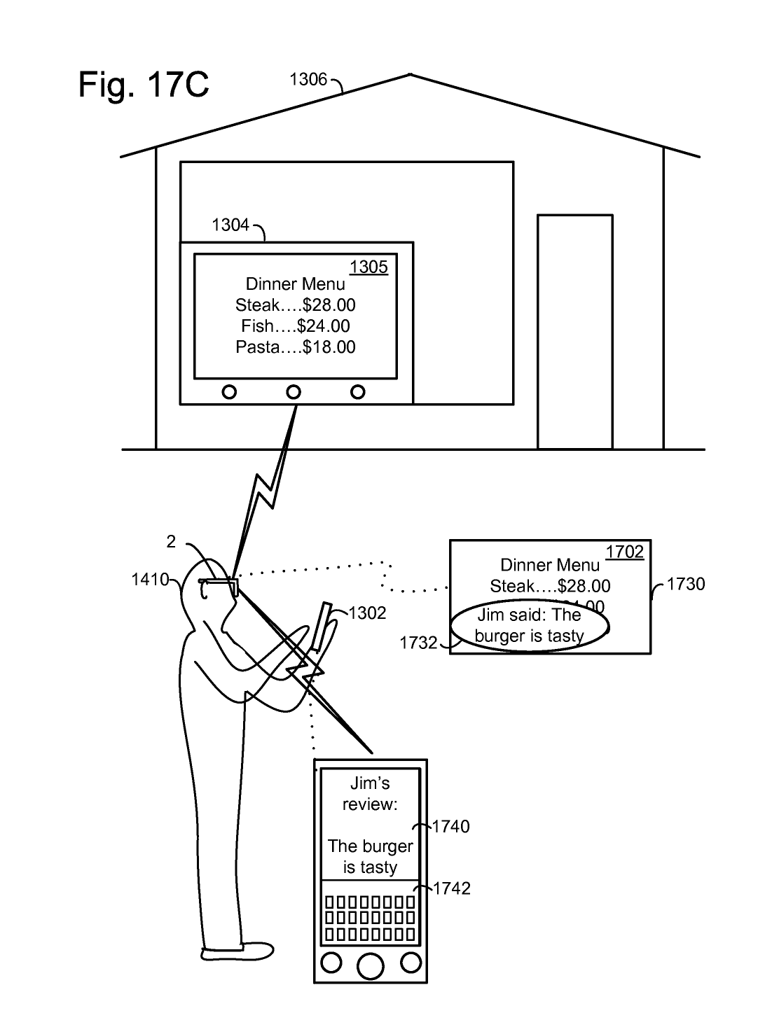

Wi-Fi is a type of wireless local area network (WLAN). Wi-Fi networks are often deployed in various locations such as office buildings, universities, retail establishments such as coffee shops, restaurants, and shopping malls, as well as hotels, public spaces such as parks and museums, airports, and so forth, as well as in homes. A Wi-Fi network includes an access point which is typically stationary and permanently installed at a location, and which includes an antenna. See access point 1307 in FIG. 17A. The access point broadcasts a message over a range of several meters to much longer distances, advertising its service set identifier (SSID), which is an identifier or name of the particular WLAN. The SSID is an example of a signature of an EM signal. The signature is some characteristic of a signal which can be obtained from the signal, and which can be used to identify the signal when it is sensed again.

The SSID can be used to access a database which yields the corresponding location. Skyhook Wireless, Boston, Mass., provides a Wi-Fi® Positioning System (WPS) in which a database of Wi-Fi® networks is cross-referenced to latitude, longitude coordinates and place names for use in location-aware applications for cell phones and other mobile devices. A computing device can determine that it is at a certain location by sensing wireless signals from a Wi-Fi network, Bluetooth network, RF or infrared beacon, or a wireless point-of-sale terminal.

As discussed in connection with FIG. 8, BLUETOOTH (IEEE 802.15.1) is an open wireless protocol for exchanging data over short distances from fixed and mobile devices, creating personal area networks (PANs) or piconets.

IrDA® is a communications protocol for short range exchange of data over infrared light such as for use in personal area networks. Infrared signals can also be used between game controllers and consoles and for TV remote controls and set top boxes, for instance. IrDa, infrared signals generally, and optically signals generally, may be used.

An RF beacon is a surveyed device which emits an RF signal which includes an identifier which can be cross referenced to a location in a database by an administrator who configures the beacon and assigns the location. An example database entry is: Beacon_ID=12345, location=coffee shop.

GPS signals 922 are emitted from satellites which orbit the earth, and are used by a computing device to determine a geographical location, such as latitude, longitude coordinates, which identifies an absolute position of the computing device on earth. This location can be correlated to a place name such as a user' home using a lookup to a database.

Global System for Mobile communication (GSM) signals 924 are generally emitted from cell phone antennas which are mounted to buildings or dedicated towers or other structures. In some cases, the sensing of a particular GSM signal and its identifier can be correlated to a particular location with sufficient accuracy, such as for small cells In other cases, such as for macro cells, identifying a location with desired accuracy can include measuring power levels and antenna patterns of cell phone antennas, and interpolating signals between adjacent antennas.

In the GSM standard, there are five different cell sizes with different coverage areas. In a macro cell, the base station antenna is typically installed on a mast or a building above average roof top level and provides coverage over a couple of hundred meters to several tens of kilometers. In a micro cell, typically used in urban areas, the antenna height is under average roof top level. A micro cell typically is less than a mile wide, and may cover a shopping mall, a hotel, or a transportation hub, for instance. Picocells are small cells whose coverage diameter is a few dozen meters, and are mainly used indoors. Femtocells are smaller than picocells, may have a coverage diameter of a few meters, and are designed for use in residential or small business environments and connect to a service provider's network via a broadband internet connection.

Block 926 denotes the use of a proximity sensor. A proximity sensor can detect the presence of an object such as a person within a specified range such as several feet. For example, the proximity sensor can emit a beam of electromagnetic radiation such as an infrared signal which reflects off of the target and received by the proximity sensor. Changes in the return signal indicate the presence of a human, for instance. In another approach, a proximity sensor uses ultrasonic signals. A proximity sensor provides a mechanism to determine if the user is within a specified distance of a computing device which is capable of participating in a transfer of content. As another example, a proximity sensor could be depth map based or use infrared ranging. For example, the hub 12 could act as a proximity sensor by determining the distance of the user from the hub. There are many options to determine proximity. Another example is a photoelectric sensor comprising an emitter and receiver which work using visible or infrared light, for instance.

Block 928 denotes determining the location from one or more of the available sources. Location-identifying information can be stored, such as an absolute location (e.g., latitude, longitude) or a signal identifier which represents a location. For example, Wi-Fi signal identifier can be an SSID, in one possible implementation. An IrDA signal and RF beacon will typically also communicate some type of identifier which can be used as a proxy for location. For example, when a POS terminal at a retail store communicates an IrDA signal, the signal will include an identifier of the retail store, such as “Sears, store #100, Chicago, Ill.” The fact that a user is at a POS terminal in a retail store can be used to trigger the transfer of an image from the POS terminal to the HMD device, such as an image of a sales receipt or of the prices of objects which are being purchase as they are processed/rung up by a cashier.

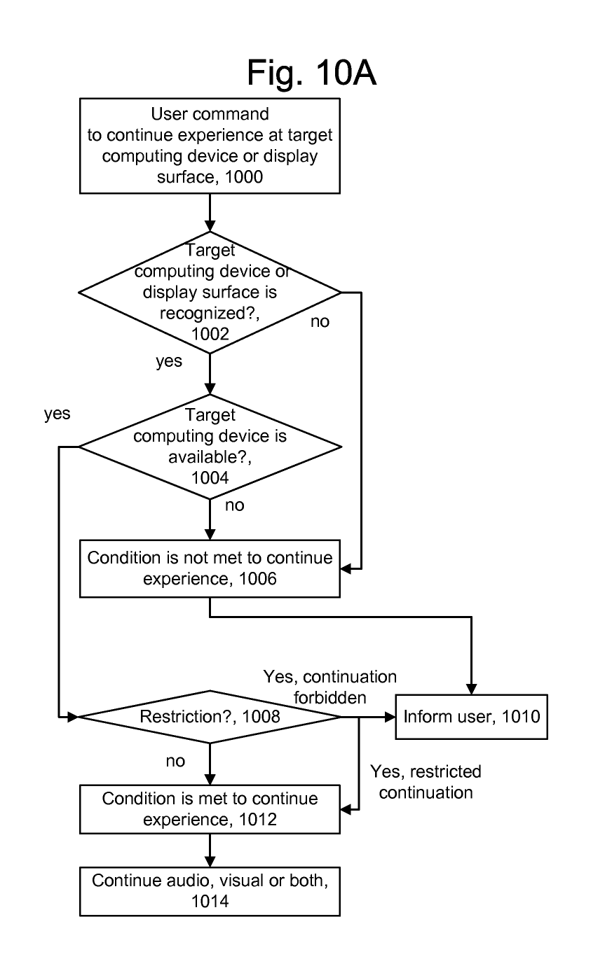

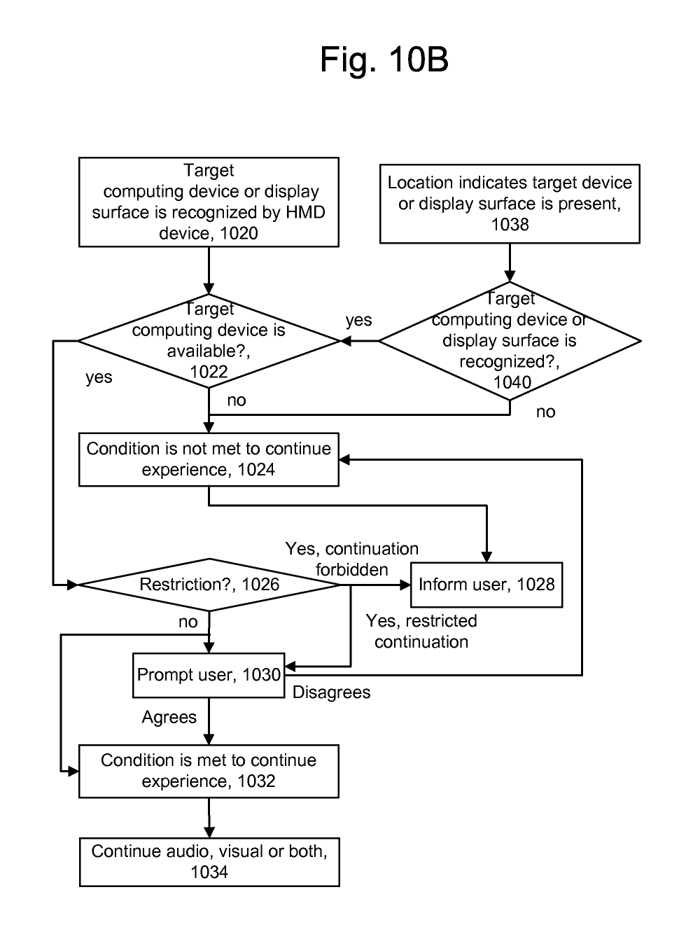

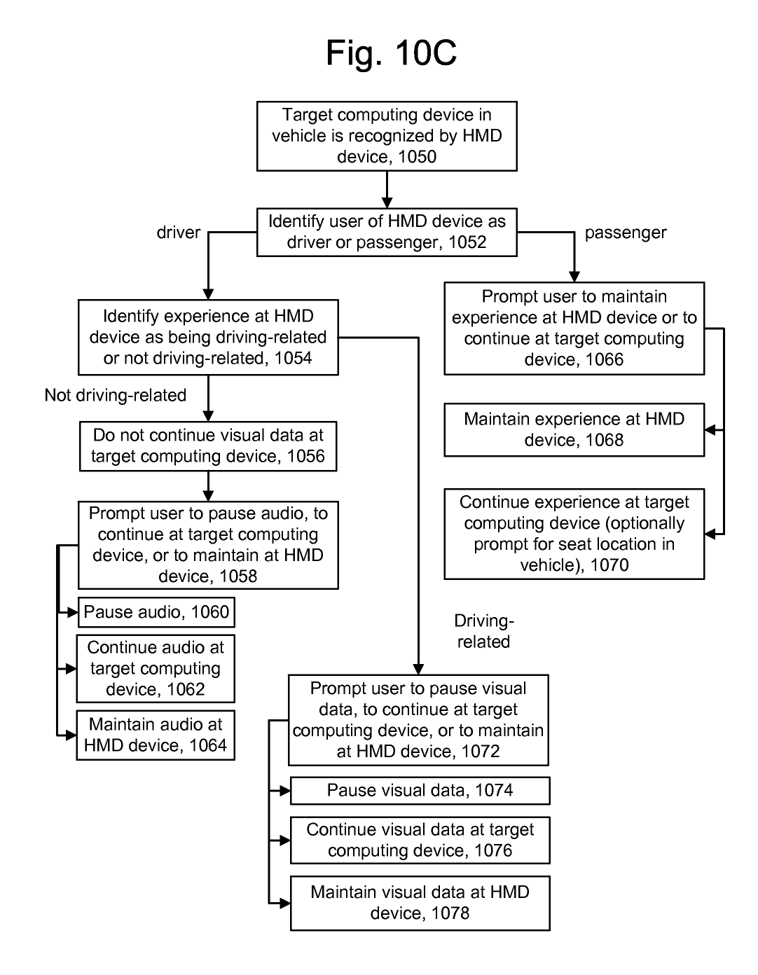

FIG. 10A depicts an example scenario of step 904 of FIG. 9A for determining if a condition is met to continue an experience on target computing device or display surface. This scenario is initiated by a user entering a command to continue an experience at a target computing device or display surface. For instance, the user may be in a location in which the user wants the continuation to occur. As an example, the user may be watching a movie using the HMD device while walking home. When the user walks into his or her home, the user may want to continue watching the movie on a television in the home. The user may issue a command, e.g., a gesture or spoken command such as: “Transfer movie to TV.” Or, the user may be participating in a gaming experience, either alone or with other players, which the user wishes to continue on a target computing device. The user may issue a command such as: “Transfer game to TV.”

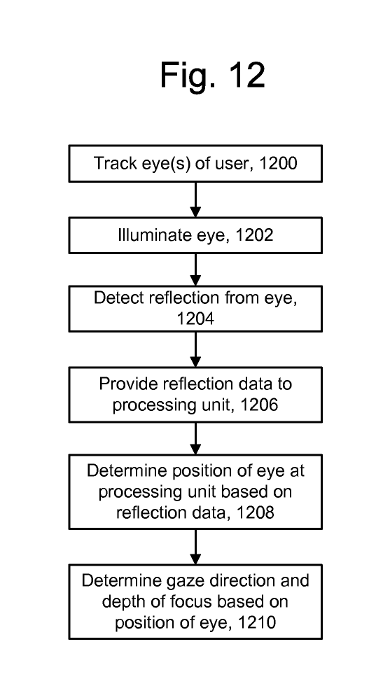

Decision step 1002 determines whether the target computing device is recognized. For example, the HMD device may determine if the television is present via a wireless network, or it may attempt to recognize visual features of the television using the front-facing camera, or it may determine that the user is gazing at the target computing device (see FIG. 12 for further details). If decision step 1002 is false, the condition is not met to continue the experience, at step 1006. The user may be informed of this fact at step 1010, e.g., via a visual or audible message, such as “TV is not recognized.”

If decision step 1002 is true, decision step 1004 determines whether the target computing device is available (when the target is a computing device). When the target is a passive display surface, it may be assumed to be always available, in one approach. A target computing device may be available, e.g., when it is not busy performing another task, or is performing another task which is of lower priority than a task of continuing the experience. For example, a television may not be available if it is already in use, e.g., the television is powered on and is being watched by another person, in which case it may not be desired to interrupt the other person's viewing experience. The availability of a target computing device could also depend on the availability of a network which connects the HMD device and the target computing device. For instance, the target computing device may be considered to be unavailable if an available network bandwidth is too low or a network latency is too high.

If decision step 1004 is false, the condition is not met to continue the experience, at step 1006. If decision step 1004 is true, decision step 1008 determines if any restrictions apply which would prevent or limit the continuation of the experience. For example, the continuation at the television may be restricted so that it is not permitted at a certain time of day, e.g., late at night, or in a time period in which a user such as a student is not allowed to use the television. Or, the continuation at the television may be restricted so that only the visual portion is allowed to be continued late at night, with the audio off or set at a low level, or with the audio being maintained at the HMD device. In the case where the continuation is at a remote television such as at another person's home, the continuation may be forbidden at certain times and days, typically as set by that another person.

If decision step 1008 is true, one of two paths can be followed. In one path, the continuation is forbidden, and the user can optionally be informed of this at step 1010, e.g., by a message: “Transfer of the movie to the TV at Joe's house right now is forbidden.” In the other path, a restricted continuation is allowed, and step 1012 is reached, indicating that the condition is met to continue the experience. Step 1012 is also reached if decision step 1008 is false. Step 1014 continues audio or visual portions of the experience, or both the audio and visual portions, at the target computing device. For example, a restriction may allow only the visual or audio portion to be continued at the target computing device.

The process shown can similarly be used as an example scenario of step 914 of FIG. 9A. In this case, the source of the content is a target computing device and the target is the HMD device, for instance.

FIG. 10B depicts another example scenario of step 904 of FIG. 9A for determining if a condition is met to continue an experience on target computing device or display surface. In one situation, at step 1020, the target computing device or display surface is recognized by the HMD device. For example, as the user walks into his or her home, the HMD device can detect that a target computing device such as a television is present, e.g., using a wireless network. A determination could also be made that the user is looking at the television. In another situation, at step 1038, location data obtained by the HMD device indicates that the target computing device or display surface is present. For example, the location data may be GPS data which indicates that the user is at the home. Decision step 1040 determines whether the target computing device or display surface is recognized by the HMD device. If decision step 1040 is true, decision step 1022 is reached. Decision step 1022 determines whether the target computing device is available. If decision step 1022 or 1040 is false, step 1024 is reached, and the condition is not met to continue the experience.

If decision step 1022 is true, decision step 1026 determines whether a restriction applies to the proposed continuation. If a restriction applies such that the continuation is forbidden, step 1028 is reached in which the user can be informed of the forbidden continuation. If the continuation is restricted, or if there is no restriction, step 1030 can prompt the user to determine if the user agrees with carrying out the continuation. For example, a message such as “Do you want to continue watching the movie on the television?” can be used. If the user disagrees, step 1024 is reached. If the user agrees, step 1032 is reached and the condition is met to continue the experience.

If step 1026 is false, step 1030 or 1032 can be performed next. That is, prompting of the user can be omitted.

Step 1034 continues audio or visual portions of the experience, or both the audio and visual portions, at the target computing device.

The process show can similarly be used as an example scenario of step 914 of FIG. 9A. In this case, the source of the content is the target computing device and the target is the source HMD device, for instance.

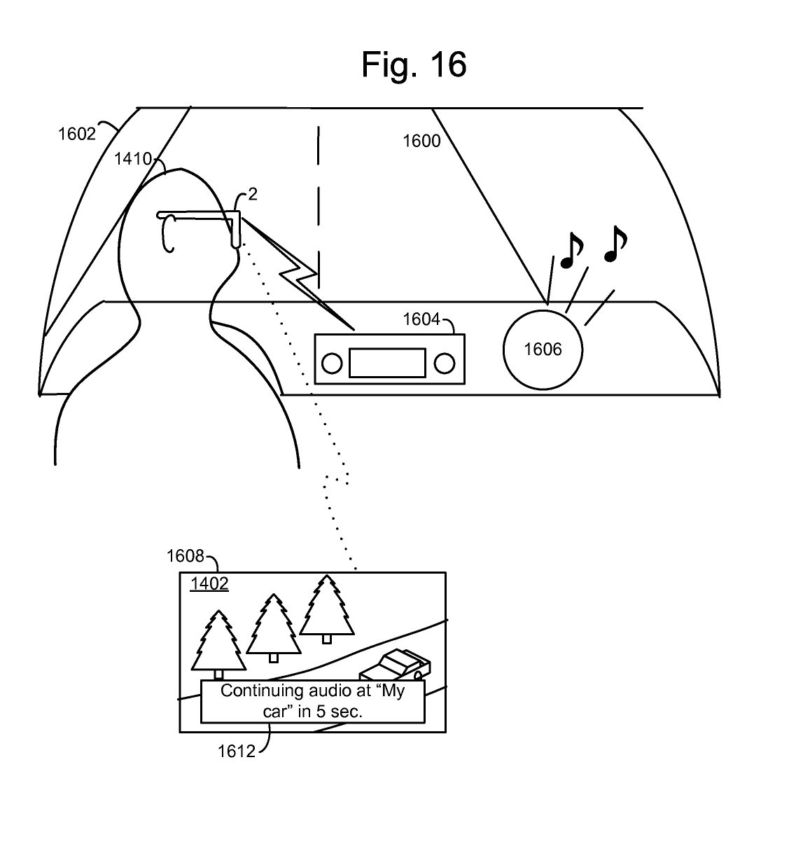

FIG. 10C depicts another example scenario of step 904 of FIG. 9A for determining if a condition is met to continue an experience on a target computing device. This scenario relates, e.g., to FIG. 16. At step 1050, a target computing device in a vehicle is recognized by a source HMD device. Step 1052 identifies the user of the HMD device as the driver or a passenger. In one possible approach, the position of the user in the vehicle can be detected by a directional antenna of the in-vehicle target computing device. Or, a sensor in the vehicle such as a weight sensor in a seat can detect that the user is sitting in the driver's seat and is therefore the driver. If the user is the driver, step 1054 identifies the experience at the HMD device as being driving-related or not driving related. A driving-related experience may include display or audible directions of a map or other navigation information, for instance, which is important to continue while the user is driving. An experience which is not driving-related may be a movie, for instance. If the experience is not driving-related, at step 1056, and includes visual data, the visual data is not continued at the target computing device for safety reasons. If the experience includes audio data, step 1058 prompts the user to pause the audio (in which case step 1060 occurs), continue the audio at the target computing device (in which case step 1062 occurs) or maintain the audio at the HMD device (in which case step 1064 occurs).

If the user is a passenger, step 1066 prompts the user to maintain the experience at the HMD device (in which case step 1068 occurs), or to continue the experience at the target computing device (in which case step 1070 occurs). Step 1070 optionally prompts the user for the seat location in the vehicle.

Generally, there is a fundamental difference in behavior if the HMD user/wearer is the driver, or a passenger in a car. If the user is the driver, audio may be transferred to the car's audio system as the target computing device, and video may transfer to, e.g., a heads up display or display screen in the car. Different types of data can be treated differently. For instance, driving-related information, such as navigation information, which is considered appropriate and safe to display while the user is driving, may automatically transfer to the car's computing device, but movie playback (or other significantly distracting content) should be paused for safety reasons. Audio, such as music/MP3s can default to transferring, while providing the user with the option to pause (save state) or transfer. If the HMD wearer is a passenger in the vehicle, the user may have the option to retain whatever type of content their HMD is currently providing, or may optionally transfer audio and/or video to the car's systems, noting a potential different experience for front and rear seated passengers, who may have their own video screens and or audio points in the car (e.g., as in an in-vehicle entertainment system).

FIG. 11 is a flow chart describing further details of step 906 or 916 of FIG. 9A for communicating data to target computing device. Step 1100 involves communicating data to the target computing device. This can involve different approaches. In one approach, step 1102 communicates a network address of the content to the target computing device. For example, consider an HMD device which receives streaming audio and/or video from a network location. By communicating the network address from the HMD device to the target computing device, the target computing device can start to access the content using the network address. Examples of a network address include an IP address, URL and file location in a directory of a storage device which stores the audio and/or visual content.

In another approach, step 1104 communicates a file location to the target computing device to save a current status. For example, this can be a file location in a directory of a storage device. An example is transferring a movie from an HMD device to the target computing device, watching it further on the target computing device, and stopping the watching before an end of the movie. In this case, the current status can be the point at which the movie stopped. In another approach, step 1106 communicates the content to the target computing device. For example, for audio data this can include communicating one or more audio files which use a format such as WAV or MP3. This step could involve content which is available only at the HMD device. In other cases, it may be more efficient to direct the target computing device to a source for the content.

In another approach, step 1108 determines the capabilities of the target computing device. The capabilities could involve a communication format or protocol used by the target computing device, e.g., encoding, modulation or RF transmission capabilities, such as a maximum data rate, or whether the target computing device can use a wireless communication protocol such as Wi-Fi®, BLUETOOTH® or IrDA®, for instance. For visual data, the capabilities can indicate a capability regarding, e.g., an image resolution (an acceptable resolution or range of resolutions, a screen size and aspect ratio (an acceptable aspect ratio or range of aspect ratios), and for video, a frame/refresh rate (an acceptable frame rate or range of frame rates) among other possibilities. For audio data, the capabilities can indicate the fidelity, e.g., whether mono, stereo and/or surround sound (e.g., 5.1 or five-channel audio such as DOLBY DIGITAL or DTS) audio can be played. The fidelity can also be expressed by the audio bit depth, e.g., number of bits of data for each audio sample. The resolution of the audio and video together can be considered to be an “experience resolution” capability which can be communicated.

The HMD device can determine the capabilities of a target computing device in different ways. In one approach, the HMD device stores records in a local non-volatile storage of the capabilities of one or more other computing devices. When a condition is met for continuing an experience at a target computing device, the HMD obtains an identifier from the target computing device and looks up the corresponding capabilities in the records. In another approach, the capabilities are not known by the HMD device beforehand, but are received from the target computing device at the time the condition is met for continuing an experience at the target computing device, such as by the target computing device broadcasting its capabilities on a network and the HMD device receiving this broadcast.

Step 1110 processes the content based on the capabilities, to provide processed content. For example, this can involve transforming the content to a format which is suitable or better suited to the capabilities of the target computing device. For example, if the target computing device is a cell phone with a relatively small screen, the HMD device may decide to down sample or reduce the resolution of visual data, e.g., from high resolution to low resolution, before transmitting it to the target computing device. As another example, the HMD device may decide to change the aspect ratio of visual data before transmitting it to the target computing device. As another example, the HMD device may decide to reduce the audio bit depth of audio data before transmitting it to the target computing device. Step 1112 includes communicating the processed content to the target computing device. For instance, the HMD device can communicate with the target computing device via a LAN and/or WAN, either directly or via one or more hubs.

Step 1113 involves determining network capabilities of one or more networks. This involves taking into account the communication medium. For example, if an available bandwidth is relatively low on the network, the computing device system may determine that a lower resolution (or higher compression of signal) is most appropriate. As another example, if the latency is relatively high on the network, the computing device may determine that a longer buffer time is suitable. Thus, a source computing device can make a decision based not just on the capabilities of the target computing device, but also on the network capabilities. Generally, the source computing device can characterize the parameters of the target computing device and provide an optimized experience.

Moreover, in many cases, it is desirable for a time-varying experience to be continued at the target computing device in a seamless, uninterrupted manner, so that the experience continues at the target computing device substantially at a point at which the experience ended at the HMD device. That is, the experience at the target computing device can be synchronized with the experience at the source HMD device, or vice-versa. A time-varying experience is an experience that varies with time. In some cases, the experience progresses over time at a predetermined rate which is nominally not set by the user, such as when an audio and/or video file is played. In other cases, the experience progresses over time at a rate which is set by the user, such as when a document is read by the user, e.g., an electronic book which is advanced page by page or in other increments by the user, or when a slide show is advanced image by image by the user. Similarly, a gaming experience advances at a rate and in a manner which is based on inputs from the HMD user and optionally from other players.

For an electronic book or other document, the time-varying state can indicate a position in a document (see step 1116), where the position in the document is partway between a start and an end of the document. For a slide show, the time-varying state can indicate the last displayed image or the next to be displayed image, e.g., identifiers of the images. For a gaming experience, the time-varying state can indicate a status of the user in the game, such as points earned, a location of an avatar of the user in a virtual world, and so forth. In some cases, a current status of the time-varying state may be indicated by at least one of a time duration, a time stamp and a packet identifier of the at least one of the audio and the visual content.

For instance, the playback of audio or video can be measured based on an elapsed time since the start of the experience or since some other time marker. Using this information, the experience can be continued at the target computing device starting at the elapsed time. Or, a time stamp of a last played packet can be tracked, so that the experience can be continued at the target computing device starting at a packet having the same time stamp. Playing of audio and video data typically involves digital-to-analog conversion of one or more streams of digital data packets. Each packet has a number or identifier which can be tracked so that the sequence can begin playing at about the same packet when the experience is continued at the target computing device. The sequence may periodically have specified packets at access points at which playing can begin.

As an example in a direct transfer situation, the state can be stored in an instruction set which is transmitted from the HMD device to the target computing device. The user of the HMD device may be watching the movie “Titanic.” To transfer this content, an initial instruction might be: home TV, start playing move “Titanic,” and a state transfer piece might be: start replay at time stamp 1 hr, 24 min from start. The state can be stored on the HMD device or at a network/cloud location.

In one approach, to avoid an interruption, such when the experience is stopped at the HMD device and started at the target computing device, it is possible to impose a slight delay which provides time for the target computing device to access and begin playing the content before stopping the experience at the HMD device. The target computing device can send a confirmation to the HMD device when the target computing device has successfully accessed the content, in response to which the HMD device can stop its experience. Note that the HMD device or target computing device can have multiple concurrent experiences, and a transfer can involve one or more of the experiences.

Accordingly, step 1114 determines a current status of a time-varying state of the content at the HMD device. For instance, this can involve accessing data in a working memory. In one option, step 1116 determines a position (e.g., a page or paragraph) in a document such as an electronic book. In another option, step 1118 determines a time duration, time stamp and/or packet identifier for video or audio.

The above discussion relates to two or more computing devices, at least one of which may be an HMD device.

FIG. 12 depicts a process for tracking a user's gaze direction and depth of focus such as for use in step 904 or 914 of FIG. 9A generally, and more specifically, for use in step 1002 of FIG. 10A or steps 1020 and 1040 of FIG. 10B, to determine if a target computing device or display surface is recognized. Step 1200 involves tracking one or both eyes of a user using the technology described above. In step 1202, the eye is illuminated, e.g., using infrared light from several LEDs of the eye tracking illumination 134A in FIG. 3. In step 1204, the reflection from the eye is detected using one or more infrared eye tracking cameras 134B. In step 1206, the reflection data is provided to the processing unit 4. In step 1208, the processing unit 4 determines the position of the eye based on the reflection data, as discussed above. Step 1210 determines a gaze direction and a focal distance.

In one approach, the location of the eyeball can be determined based on the positions of the cameras and LEDs. The center of the pupil can be found using image processing, and ray which extends through the center of the pupil can be determined as a visual axis. In particular, one possible eye tracking technique uses the location of a glint, which is a small amount of light that reflects off the pupil when the pupil is illuminated. A computer program estimates the location of the gaze based on the glint. Another possible eye tracking technique is the Pupil-Center/Corneal-Reflection Technique, which can be more accurate than the location of glint technique because it tracks both the glint and the center of the pupil. The center of the pupil is generally the precise location of sight, and by tracking this area within the parameters of the glint, it is possible to make an accurate prediction of where the eyes are gazing.

In another approach, the shape of the pupil can be used to determine the direction in which the user is gazing. The pupil becomes more elliptical in proportion to the angle of viewing relative to the straight ahead direction.

In another approach, multiple glints in an eye are detected to find the Sd location of the eye, estimate the radius of the eye, and then draw a line through the center of the eye through the pupil center to get a gaze direction.

The gaze direction can be determined for one or both eyes of a user. The gaze direction is a direction in which the user looks and is based on a visual axis, which is an imaginary line drawn, e.g., through the center of the pupil to the center of the fovea (within the macula, at the center of the retina). At any given time, a point of the image that the user is looking at is a fixation point, which is at the intersection of the visual axis and the image, at a focal distance from the HMD device. When both eyes are tracked, the orbital muscles keep the visual axis of both eyes aligned on the center of the fixation point. The visual axis can be determined, relative to a coordinate system of the HMD device, by the eye tracker. The image can also be defined relative to the coordinate system of the HMD device so that it is not necessary to translate the gaze direction from the coordinate system of the HMD device to another coordinate system, such as a world coordinate system. An example of a world coordinate system is a fixed coordinate system of a room in which the user is located. Such a translation would typically require knowledge of the orientation of the user's head, and introduces additional uncertainties.

If the gaze direction is determined to point at a computing device for some minimum time period, this indicates that the user is looking at the computing device. In this case, the computing device is considered to be recognized and is as a candidate for a content transfer. In one approach, an appearance of the computing device can be recognized by the forward facing camera of the HMD device, by comparing the appearance characteristics to known appearance characteristics of the computing device, e.g., size, shape, aspect ratio and/or color.

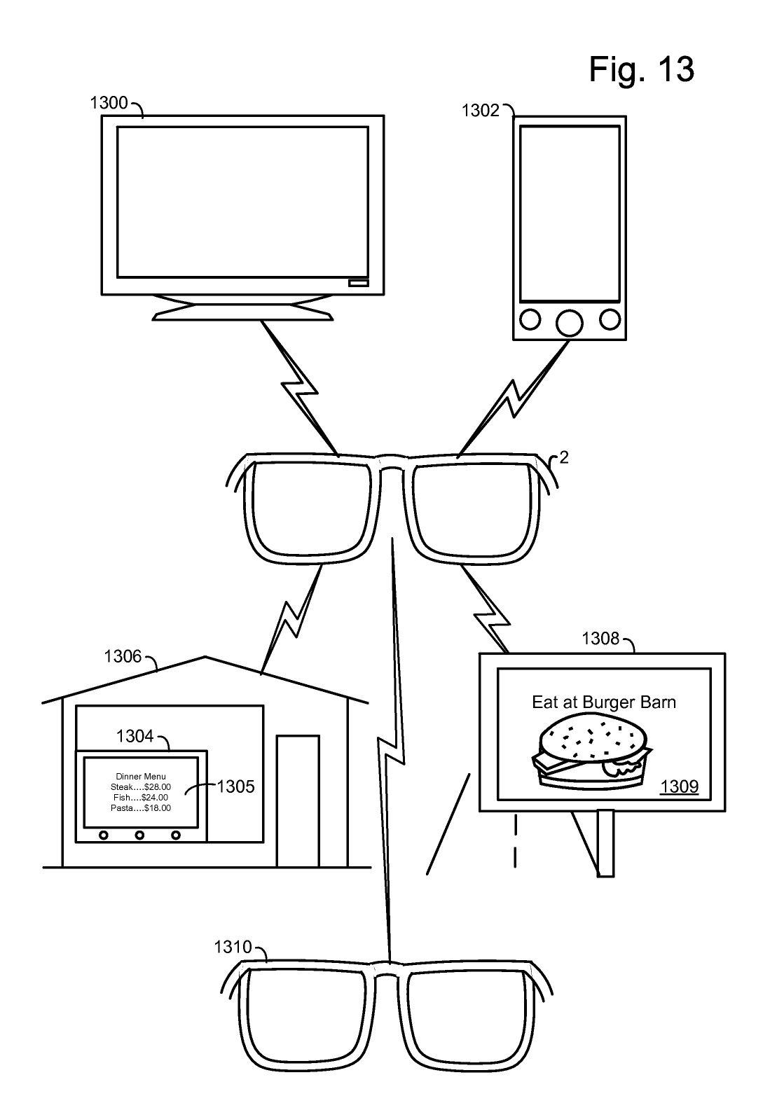

FIG. 13 depicts various communication scenarios involving one or more HMD devices and one or more other computing devices. The scenarios can involve an HMD device 2 and one or more of a television (or computer monitor) 1300, a cell phone (or tablet or PDA) 1302, an electronic billboard 1308 with a display 1309, another HMD device 1310 and a business facility 1306 such as a restaurant which has a display device 1304 with a display 1305. In this example, the business is a restaurant which posts its menu on the display device 1304 such as a menu board.

FIG. 14A depicts a scenario in which an experience at an HMD device is continued at a target computing device such as the television 1300 of FIG. 13, based on a location of the HMD device. When a user 1410 wearing the HMD device 2 enters into a specified location 1408, a condition is met for continuing an experience at the HMD device at the television 1300. The display 1400 represents the image on the HMD device 2, and includes a background region 1402 (e.g., still or moving images, optionally accompanied by audio) as an experience. When the HMD device determines that it is in the specified location, it may generate a message in the foreground region 1404 which asks the user if he or she wants to continue the experience of the HMD device at a computing device which has been identified as “My living room TV.” The user can respond affirmatively or negatively with some control input such as a hand gesture, nodding of the head, or voice command. If the user responds affirmatively, the experience is continued at the television 1300 as indicated by the display 1406. If the user responds negatively, the experience is not continued at the television 1300 and may continue at the HMD device or be stopped altogether.

In one approach, the HMD device determines that it is in the location 1408 based on a proximity signal, an infrared signal, a bump, a pairing of the HMD device with the television, or using any of the techniques discussed in connection with FIG. 9B.

As an example, the location 1408 can represent the user's house, so that when the user enters the house, the user has the option to continue an experience at the HMD device on target computing device such as the television. In one approach, the HMD device is preconfigured so that it associates the television 300 and a user-generated description (My living room TV) with the location 1408. Settings of the television such as volume level can be pre-configured by the user or set to a default.

Instead of prompting the user to approve the transfer to the television, e.g., using the message in the foreground region 1404, the continuation of the experience can occur automatically, with no user intervention. For example, the system can be set up or preconfigured so that a continuation is performed when one or more conditions are detected. In one example, the system can be set up so that if the user is watching a movie on the HMD device and arrives at their home, an automatic transfer of the movie to a large screen television in the home occurs. The user can set up a configuration entry in a system setup/configuration list to do this, e.g., via a web-based application. If there is no preconfigured transfer on file with the system, it may prompt the user to see if they wish to perform the transfer.

A decision of whether to continue the experience can account for other factors, such as whether the television 1300 is currently being used, time of day or day of week. Note that it is also possible to continue only the audio or visual portion of content which includes both audio and video. For example, if the user arrives home late at night, it might be desired to continue the visual content but not the audio content at the television 1300, e.g., to avoid waking other people in the home. As another example, the user may desire to listen to the audio portion of the content, such as via the television or a home audio system, but discontinue the visual content.

In another option, the television 1300 is at a remote location from the user, such as at the home of a friend or family member, as described next.

FIG. 14B depicts a scenario in which an experience at an HMD device is continued at a television which is local to the HMD device and at a television which is remote from the HMD device, based on a location of the HMD device. In this example, the experience has been continued at the television 1300 which is local to the user and continues also at the HMD device. The HMD device provides a display 1426 with the background image 1402 and a message as a foreground image 1430 which asks the user if the user desires to continue the experience at a computing device (e.g., a television 1422) which has been identified as being at “Joe's house.”

The message could alternatively be located elsewhere in the user's field of view such as laterally of the background image 1402. In another approach, the message could be provided audibly. Furthermore, the user provides a command using a hand gesture. In this case, the hand 1438 and its gesture (e.g., a flick of the hand) are detected by a forward facing camera 113 with a field of view indicated by dashed lines 1434 and 1436. When an affirmative gesture is given, the experience is continued at the television 1422 as display 1424. The HMD device can communicate with the remote television 1422 via one or more networks such as LANs in the user's and a friend's homes, and the Internet (a WAN), which connects the LANs.

The user could alternatively provide a command by a control input to a game controller 1440 which is in communication with the HMD device. In this case, a hardware based input device is manipulated by the user.

Regardless of the network topologies involved in reaching a target computing device or display surface, content can be transferred to the target computing device or display surface which is in a user's immediate space or to other known (or discoverable) computing devices or display surfaces in some other place.

In one option, the experience at the HMD device is continued automatically at the local television 1300 but requires a user command to be continued at the remote television 1422. A user of the remote television can configure it to set permissions as to what content will be received and played. The user of the remote television can be prompted to approve any experience at the remote television. This scenario could occur if the user wishes to share an experience with a friend, for instance.

FIG. 14C depicts a scenario in which visual data of an experience at an HMD device is continued at a computing device such as the television 1300 of FIG. 13, and audio data of an experience at an HMD device is continued at a computing device such as a home high-fidelity stereo system 1460 (e.g., comprising an audio amplifier and speakers). When a user 1410 wearing the HMD device 2 enters into a specified location 1408, a condition is met for continuing the experience as described. When the HMD device determines that it is in the specified location, it may generate a message in the foreground region 1452 which asks the user if he or she wants to continue the visual data of the experience at a computing device which has been identified as “My living room TV,” and the audio data of the experience at a computing device which has been identified as “My home stereo system.” The user can respond affirmatively, in which case the visual data of the experience is continued at the television 1300 as indicated by the display 1406 and the audio data of the experience is continued at the stereo system 1460. The HMD device can automatically decide that the visual data should be continued on the television and the audio data should be continued on the home high-fidelity stereo system. In this situation, at least one control circuit of the HMD device determines that a condition is met to provide a continuation of the visual content at one target computing device (e.g., the television 1300) and a continuation of the audio content at another computing device (e.g., the home stereo system 1460).

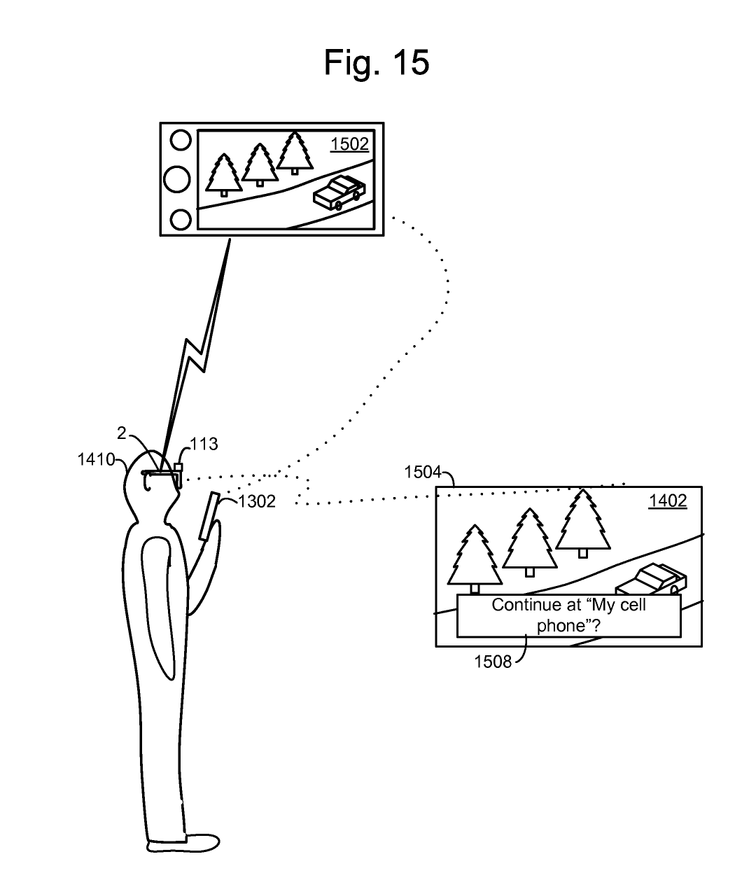

FIG. 15 depicts a scenario in which an experience at an HMD device is continued at a computing device such as a cell phone, based on a voice command of a user of the HMD device. The user is holding a cell phone (or tablet, laptop or PDA) 1302 in the left hand and making a voice command to initiate the continuation. The display 1504 of the HMD device includes the background image 1402 and a message as a foreground image 1508 which asks: “Continue at “My cell phone?” When the command indicates an affirmative response, the experience is continued at the cell phone 1302 using display 1502. This scenario could occur, e.g., when the user powers on the cell phone and is recognized by the HMD device, e.g., by sensing an inquiry message broadcast by the cell phone, and/or the HMD device is paired with the cell phone such as in a master-slave pairing using BLUETOOTH. The user could also access an application on the cell phone to initiate the transfer. As before, the continuation at the cell phone could alternatively occur automatically, without prompting the user.

FIG. 16 depicts a scenario in which only the audio portion of an experience at an HMD device is continued at a computing device in a vehicle. Refer also to FIG. 10C. The user is in a vehicle 1602 on a road 1600. The vehicle has a computing device 1604 such as a network-connected audio player, e.g., an MP3 player with BLUETOOTH connectivity, including a speaker 1606. In this scenario, the user enters the car wearing the HMD device on which an experience comprising audio and visual content is in progress. The HMD device determines that it is near the computing device 1604, e.g., by sensing an inquiry message broadcast by the computing device 1604 and automatically continues only the audio content, but not the visual content, on the computing device 1604, e.g., based on safety concerns. The experience includes a display 1608 having the background image 1402 and a message as a foreground image 1612 which states: “Continuing audio at “My car” in 5 sec.” In this case, a countdown informs the user that the continuation will occur. Optionally, the HMD device continues the experience including visual content while the user is in the car but senses when the car begins moving, e.g., based on an accelerometer or based on changing locations of a GPS/GSM signal, and responds by stopping the visual content but continuing the audio content on the HMD device or computing device 1604. The stopping of the content can be based on a context sensitive rule such as: Don't play a movie while I′m in a moving car.

FIG. 17A depicts a scenario in which an experience at a computing device at a business is continued at an HMD device. A business facility 1306 such as a restaurant has a computing device 1304 such as a computer monitor which provides a display 1305 of its dinner menu as an experience. Accompanying audio such as music or an announcer's sale pitch could also be provided. Such monitors are referred to as digital menu boards and typically use LCD displays and have network connectivity. Moreover, generally the monitor can be part of a smart board or smart display which is not necessarily associated with a restaurant. When the HMD device determines that the user's attention is drawn to the computing device 1304, e.g., by determining that the user is gazing at the computing device, and/or by sensing a signal from the access point 1307, it can access data from the computing device, such as a still or moving image of the menu or other information. For example, the HMD device can provide the display 1700 which includes the menu as a background region 1702 and a message as a foreground image 1704 which asks: “Take a copy of our menu?” The user can provide an affirmative command using a hand gesture, for instance, in which case the display 1706 provides the menu as the background region 1702, without the message. The hand gesture can provide the experience of grasping the menu from the computing device 1304 and placing it within the field of view of the HMD device.

The menu can be stored at the HMD device in a form which persists even after the HMD device and the computing device 1304 are no longer in communication with one another, e.g., when the HMD device is out of range of the access point. In addition to the menu, the computing device can provide other data such as special offers, electronic coupons, reviews by other customers and the like. This is an example of continuing an experience on a HMD device from another, non-HMD computing device.

In another example, the computing device 1304 is not necessarily associated with and/or located at restaurant but has the ability to send different types of information to the HMD device. In one approach, the computing device can send menus from different restaurants which are in the area and which may appeal to the HMD device user, based on known demographics and/or preferences of the user (e.g., the user likes Mexican food). The computing device may determine that the user is likely looking for a restaurant for dinner based on information such as the time of day, a determination that the user has recently looked at another menu board, and/or a determination that that the user has recently performed a search for restaurants using the HMD device or another computing device such as a cell phone. The computing device can search out information which it believes is relevant to the user, e.g., by searching for local restaurants and filtering out non-relevant information.

As the user moves around, such as by walking down a street with many such business facilities with respective computing devices, the audio and/or visual content which the HMD device receives can change dynamically based on the user's proximity to the location of each business facility. A user and HMD device can be determined to be proximate to the location of a particular business facility based on, e.g., wireless signals of the business facilities which the HMD device can detect, and perhaps their respective signal strengths, and/or GPS location data which is cross-referenced to known locations of the facilities.

FIG. 17B depicts a scenario in which the experience of FIG. 17A includes user-generated content. For a business or other organization, it has become common for patrons/customers to post comments, photos, videos or other content and make them available to friends or the general public, e.g., using social media. One scenario highlights celebrity or friends' reviews of a restaurant based on social networking data. In one example, customers of the restaurant named Joe and Jill have previously created content and associated it with the computing device 1304. The display 1710 on the HMD device includes the background region 1702 showing the menu, and a message as a foreground image 1714 which states: “Joe and Jill said . . . ” The user 1410 enters a command to access additional content of the message, e.g., using a hand gesture. The additional content is provided in the display 1716 and states: “Joe recommends the steak” and “Jill likes the pie.” The user can the enter another command which results in the display 1720 of the background region 1702 by itself.

FIG. 17C depicts a scenario in which a user generates content for the experience of FIG. 17A. There are a number of ways in which a user could provide content regarding a business such as a restaurant. For example, the user can speak into the microphone of the HMD device and have the speech be stored in an audio file, or converted to text using speech-to-text conversion. The user can enter spoken command and/or gestures to provide content. In one approach, the user “tags” the restaurant and provides content using target computing device such as the cell phone (or a tablet, laptop or PC) 1302 which includes a display area 1740 and an input area/keyboard 1742 on which a comment is typed. Here, the content is a text comment: “The burger is tasty.” The content is posted so that the display 1730 includes the content as a foreground image. Other uses can subsequently access the content as well. The content could also include audio and video. A comment could also be defined by selecting from a pre-defined list of content selections (e.g., “Great”, “ok” or “bad”). A comment could also be defined by making a selection in a predefined ranking system (e.g., select three out of five stars for a restaurant).

In another approach, a user can check in at a business location or other venue using location-based social networking website for mobile devices. Users can check in by selecting from a list of nearby venues that are located by a GPS-based application, for instance. Metrics about recurring sign-ins from the same user could be detected (e.g., Joe has been here five times this month) and displayed for other users, as well as metrics about sign-ins from friends of a given user. The additional content such as ratings which are available to a given user can be based on the user's identity, social networking friends of the user or demographics of the user, for instance.

FIG. 18 depicts an example scenario based on step 909 of FIG. 9A, describing a process for moving visual content from an initial virtual location to a virtual location which is registered to a display surface. In this approach, the visual content continues to be displayed by the HMD device, but it is registered to a location of a display device such as a blank wall or a screen in the real world. Initially, the visual content, with optional accompanying audio content, is displayed at the user's HMD device in an initial virtual location. This can be a virtual location which is not registered to a real world object. A real world object can be, e.g., a blank wall or a screen. Thus, as the user moves his or her head, the visual content appears to be in a same virtual location in the field of view, such as directly in front of the HMD device, but in different real-world locations. A condition is then met to transfer the visual content to a virtual location which is registered to a display surface.

This can be based on any of the conditions as described, including the location of the HMD device and a detected proximity to a display surface such as a blank wall, screen or 3D object. For example, a display surface can be associated with a location such as the user's home or a room in the home. In one approach, the display surface itself may not be a computing device or have the ability to communicate, but can have capabilities which are known beforehand by the HMD device, or which are communicated to the HMD device in real-time, by a target computing device. The capabilities can identify, e.g., a level of reflectivity/gain and a range of usable viewing angles. A screen with a high reflectivity will have a narrower usable viewing angle, as the amount of reflected light rapidly decreases as the viewer moves away from front of the screen.

Generally, we can classify displays which are external to an HMD device in three categories. One category includes display devices which generate a display such as via a backlit screen. These include televisions and computer monitors having electronic properties that we can sync the display to. A second category includes a random flat space such as a white wall. A third category includes a display surface that is not inherently a monitor, but is used primarily for that purpose. One example is a cinema/home theatre projection screen. The display surface has some properties that make it better as a display compared to a plain white wall. For the display surface, its capabilities/properties and existence can be broadcast or advertised to the HMD device. This communication may be in the form of a tag/embedded message that the HMD can use to identify the existence of the display surface, and note its size, reflective properties, optimum viewing angle and so forth, so that the HMD device has the information needed to determine to transfer the image to the display surface. This type of transfer can include creating a hologram to make it appear as though that is where the image was transferred to, or using a pico projector/other projector technology to transfer the images as visual content, where the projector renders the visual content itself.

The visual content is transferred to a virtual location which is registered to a real-world display surface such as a blank wall, screen or 3D object. In this case, as the user moves his or her head, the visual content appears to be in the same real-world location, and not in a fixed location relative to the HMD device. Moreover, the capabilities of the display surface can be considered in the way the HMD device generates the visual content, e.g., in terms of brightness, resolution and other factors. For instance, the HMD device may user a lower brightness in rendering the visual content using its microdisplay when the display surface is a screen with a higher reflectivity, than when the display surface is a blank wall with a lower reflectivity.

Here, a display surface 1810 such as a screen appears to have the display (visual content) 1406 registered to it, so that when the user's head and the HMD device are in a first orientation 1812, the display 1406 is provided by microdisplays 1822 and 1824 in the left and right lenses 118 and 116, respectively. When the user's head and the HMD device are in a second orientation 1814, the display 1406 is provided by microdisplays 1832 and 1834 in the left and right lenses 118 and 116, respectively.

The display surface 1810 does not inherently produce a display signal itself, but can be used to host/fix an image or set of images. For example, the user of the HMD device can enter their home and replicate the current content at a home system which includes the display surface on which the visual content is presented and perhaps an audio hi-fi system on which audio content is presented. This is an option to replicate the current content at a computing device such as a television. It is even possible to replicate the content at different display surfaces, one after another, as the user moves about the house or other location.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A head-mounted display device, comprising:
at least one see-through lens;
at least one image projection source associated with the at least one see-through lens;
at least one control circuit in communication with the at least one image projection source, the at least one control circuit:
provides an experience comprising at least one of audio and visual content at the head-mounted display device;
determines if a condition is met to provide a continuation of at least part of the experience at a target computing device; and
if the condition is met, communicates data to the target computing device to allow the target computing device to provide the continuation of the at least part of the experience, the continuation of the at least part of the experience comprises at least one of the audio and the visual content.

2. The head-mounted display device of claim 1, wherein:
the at least one control circuit determines that a condition is met to provide a continuation of the visual content at one target computing device and a continuation of the audio content at another computing device.

3. The head-mounted display device of claim 1, wherein the at least one control circuit, to determine if the condition is met:
prompts the user to approve transfer of the experience to the target computing device.

4. The head-mounted display device of claim 1, wherein the at least one control circuit, to determine if the condition is met, determines if at least one of:
a gesture is performed by a user of the head-mounted display device;
a hardware based input device is manipulated by the user;
a voice command is made by the user; and
a gaze of the user indicates that the user is looking at the target computing device.

5. The head-mounted display device of claim 1, wherein the at least one control circuit, to determine if the condition is met, detects at least one of:
a proximity signal;
an infrared signal;
a bump;
a pairing of the head-mounted display device with the target computing device; and
an electromagnetic signal of an access point.

6. The head-mounted display device of claim 1, wherein:
the data comprises a file location for use by the target computing device in saving a current status of a time-varying state of at least one of the audio and the visual content.

7. The head-mounted display device of claim 1, wherein the data comprises at least one of:
at least one of the audio and the visual content;
a network address of the at least one of the audio and the visual content; and
a file storage location of the at least one of the audio and the visual content.

8. The head-mounted display device of claim 1, wherein:
the data includes a current status of a time-varying state of the at least one of the audio and the visual content, the time-varying state indicates a current position in the at least one of the audio and the visual content which is partway between a start and an end of the at least one of the audio and the visual content.

9. The head-mounted display device of claim 8, wherein:
the current status of the time-varying state is indicated by at least one of a time duration, a time stamp and a packet identifier of the at least one of the audio and the visual content.

10. The head-mounted display device of claim 1, wherein the at least one control circuit:
determines its location; and
determines if the condition is met based on the location.

11. The head-mounted display device of claim 1, wherein the at least one control circuit:
determines one or more capabilities of the target computing device; and
processes the content based on the one or more capabilities to provide processed content, the data comprises the processed content.

12. The head-mounted display device of claim 1, wherein:
the one or more capabilities comprise a capability regarding an image resolution.

13. The head-mounted display device of claim 1, wherein:
the one or more capabilities comprise a capability regarding an audio fidelity.

14. A head-mounted display device, comprising:
at least one see-through lens;
at least one microdisplay associated with the at least one see-through lens;
at least one control circuit in communication with the at least one microdisplay, the at least one control circuit:
determines if a condition is met to provide a continuation at the head-mounted display device of at least part of a experience at target computing device, the experience provided at the target computing device comprises at least one of audio and visual content;
if the condition is met, receives data from the target computing device; and
based on the data, provides, at the head-mounted display device, the continuation of the at least part of the experience, the continuation of the at least part of the experience comprises at least one of the audio and the visual content.

15. The head-mounted display device of claim 14, wherein:
the data is received at the at least one control circuit from the target computing device when the at least one control circuit and the target computing device are in communication with one another, and persists at the at least one control circuit when the at least one control circuit and the target computing device are no longer in communication with one another.

16. The head-mounted display device of claim 14, wherein:
the data includes a current status of a time-varying state of the at least one of the audio and the visual content, the time-varying state indicates a current position in the at least one of the audio and the visual content which is partway between a start and an end of the at least one of the audio and the visual content.

17. The head-mounted display device of claim 14, wherein:
the target computing device is at a business facility; and
the condition is met based on the head-mounted display device being proximate to the business facility.

18. The head-mounted display device of claim 14, wherein:
the target computing device is at a business facility; and
the data includes at least one of audio and visual content generated by patrons of the business facility.

19. A head-mounted display device, comprising:
at least one see-through lens;
at least one microdisplay associated with the at least one see-through lens;
at least one control circuit in communication with the at least one microdisplay, the at least one control circuit:
provides an experience comprising visual content at the head-mounted display device, at an initial virtual location which is not registered to a display surface;
determines if a condition is met to provide a continuation of the experience at the display surface; and
if the condition is met, modifies the experience to continue the experience at a virtual location which is registered to the display surface.

20. The head-mounted display device of claim 19, wherein:
the display device comprises a screen; and
a brightness of the experience at the virtual location which is registered to the display surface is based on a level of reflectivity of the screen.
